(19) United States
(12) Patent Application Publication
(10) Pub. No.: US 2015/0268896 A1
(43) Pub. Date: Sep. 24, 2015

(54) INFORMATION PROCESSING APPARATUS, IMAGE PROCESSING SYSTEM, AND RECORDING MEDIUM STORING AN IMAGE PROCESSING PROGRAM

(71) Applicant: Koji HAYASHI, Kanagawa (JP)

(72) Inventor: Koji HAYASHI, Kanagawa (JP)

(21) Appl. No.: 14/643,061

(22) Filed: Mar. 10, 2015

(30) Foreign Application Priority Data
Mar. 18, 2014 (JP) 2014-054308

(51) Int. Cl. G06F 3/12; H04N 1/60

(52) U.S. Cl. CPC G06F 3/1205; H04N 1/6044; H04N 1/6052; G06F 3/1253; H04N 2201/0094

(57) ABSTRACT

An information processing apparatus includes a memory that stores at least one of a captured image of printed matter printed by a first image forming apparatus and a second image forming apparatus, a scanned image of a document and a patch image, a captured image of the document and the printed matter, and a scanned image of the printed matter and the document, and an identification unit that identifies a printing color or a scanning characteristic of the first image forming apparatus and the second image forming apparatus, respectively, using at least one of the captured image of the printer matter, the scanned image of the document and the patch image, the captured image of the document and the printed matter, and the scanned image of the printed matter and the document that is stored in the memory.

### CROSS-REFERENCE TO RELATED APPLICATION

This patent application is based on and claims priority pursuant to 35 U.S.C. §119(a) to Japanese Patent Application No. 2014-054308, filed on Mar. 18, 2014 in the Japan Patent Office, the entire disclosure of which is hereby incorporated by reference herein.

### BACKGROUND

1. Technical Field

The present invention relates to an information processing apparatus, an image processing system, and a recording medium storing an image processing program.

2. Background Art

Conventionally, network printing that prints a variety of image data using image forming apparatuses connected to networks has been utilized.

As an example of network printing, a technology that delivers target images from image processing apparatuses to printers via networks such as the Internet and a Local Area Network (LAN), etc., has been proposed. In the technology described above, if an image similar to the target image has already been printed, it is possible to configure printing conditions easily by providing print condition parameters to a user.

### SUMMARY

An example embodiment of the present invention provides a novel information processing apparatus that includes a memory that stores at least one of a captured image of printed matter printed by a first image forming apparatus and a second image forming apparatus, a scanned image of a document and a patch image scanned by the first image forming apparatus and the second image forming apparatus, a captured image of the document and the printed matter printed by the first image forming apparatus and the second image forming apparatus, and a scanned image acquired by scanning the printed matter and the document by the first image forming apparatus and the second image forming apparatus, and an identification unit that identifies a printing color or a scanning characteristic of the first image forming apparatus and the second image forming apparatus, respectively, using at least one of the captured image of the printer matter, the scanned image of the document and the patch image, the captured image of the document and the printed matter, and the scanned image of the printed matter and the document that is stored in the memory.

Further example embodiments of the present invention provide a non-transitory recording medium storing an information processing program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating an image processing system as an embodiment of the present invention.

FIG. 2 is a diagram illustrating a hardware configuration of a server as an embodiment of the present invention.

FIG. 3 is a diagram illustrating a functional configuration of the server in FIG. 1 as an embodiment of the present invention.

FIGS. 4A and 4B are sequence diagrams illustrating a process executed by the image processing system as an embodiment of the present invention.

FIG. 5 is a sequence diagram illustrating a process executed by the image processing system as another embodiment of the present invention.

FIGS. 6A and 6B are sequence diagrams illustrating a process executed by the image processing system as yet another embodiment of the present invention.

FIG. 7 is a flowchart illustrating a process executed by the server as an embodiment of the present invention.

FIGS. 8A and 8B are flowcharts illustrating a process of identifying a printer executed by the server as an embodiment of the present invention.

FIG. 9 is a flowchart illustrating a process of calculating a color reproduction area executed by the server as an embodiment of the present invention.

FIGS. 10A and 10B are flowcharts illustrating a process of identifying a scanner executed by the server as an embodiment of the present invention.

FIG. 11 is a flowchart illustrating a process of identifying a multifunction peripheral (MFP) executed by the server as an embodiment of the present invention.

FIGS. 12A and 12B are flowcharts illustrating a process of identifying the image forming apparatus executed by the server if image forming apparatuses to be compared are a same type of MFP and a scanned image of a document exists, as an embodiment of the present invention.

FIG. 13 is a flowchart illustrating a process of identifying the image forming apparatuses in FIGS. 12A and 12B as an embodiment of the present invention.

FIGS. 14A and 14B are flowcharts illustrating a process of identifying an image forming apparatus executed by the server if the image forming apparatuses to be compared are a same type of MFP and a scanned image of a document does not exist, as an embodiment of the present invention.

FIGS. 15A and 15B are flowcharts illustrating a process of identifying the image forming apparatuses in FIGS. 14A and 14B as an embodiment of the present invention.

FIGS. 16A and 16B are flowcharts illustrating a process of identifying the image forming apparatuses executed by the server if the image forming apparatuses to be compared are different types of MFP as an embodiment of the present invention.

FIG. 17 is a flowchart illustrating a process of identifying the image forming apparatuses in FIGS. 16A and 16B as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the image processing system described in the conventional technology described above, it is possible to configure the printing conditions easily. However, in case of replacing an existing image forming apparatus connected to the network with another image forming apparatus, it is difficult to check if printing colors on printed matter and scanning characteristics of the image forming apparatus before being replaced and the image forming apparatus after being replaced are identical or similar.

In the following embodiment, a novel information processing apparatus that can check if printing colors on printer matter and scanning characteristics of the image forming apparatus before being replaced and the image forming apparatus after being replaced are identical or similar by user operation is provided.

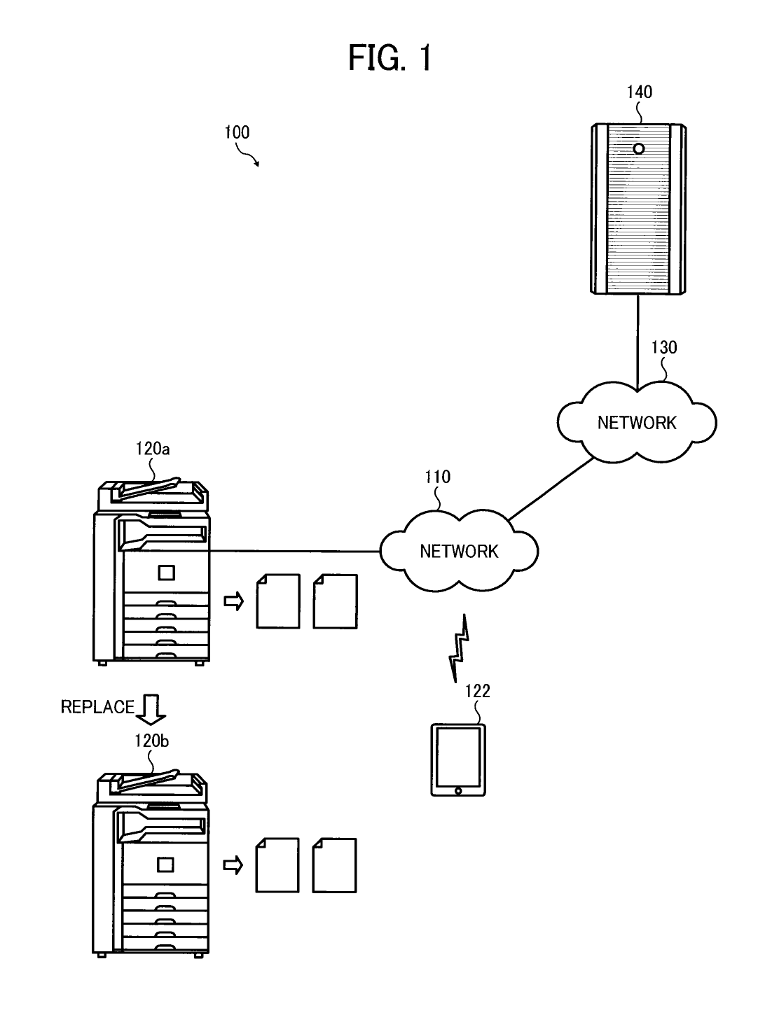

FIG. 1 is a diagram illustrating an image processing system before replacing an image forming apparatus 120a with an image forming apparatus 120b in this embodiment.

The image processing system 100 includes the image forming apparatus 120a, a portable device 122, and a server 140. The image forming apparatus 120a, the portable device 122, and the server 140 perform data communication with each other via a network 110 as a short-range network such as a LAN and a network 130 as a wide-area network such as the Internet.

The image forming apparatuses 120a and 120b are apparatuses that form various images. In the embodiment in which the MFP is adopted as the image forming apparatuses 120a and 120b, the image forming apparatuses 120a and 120b print a target image that the server 140 and the portable device 122 provide. In addition, the image forming apparatuses 120a and 120b print a patch image that includes unicolor patches in yellow (Y), magenta (M), cyan (C), and black (K). Furthermore, the image forming apparatuses 120a and 120b scan printed matter on which the target image and the patch images are printed and output and any document and transfer it to the server 140.

In the embodiment in which the printer is adopted as the image forming apparatuses 120a and 120b, the image forming apparatuses 120a and 120b print a target image that the server 140 and the portable device 122 provide. In addition, the image forming apparatuses 120a and 120b print the patch image stored in a storage device.

In the embodiment in which the scanner is adopted as the image forming apparatuses 120a and 120b, the image forming apparatuses 120a and 120b scan printed matter of the patch image and any document, transfers the scanned image to the server 140, and instructs the server 140 to store the scanned image.

The portable device 122 is an information processing apparatus that includes a capturing device. The portable device performs data communication with the server 140 via an access point (not shown in figures) connected to the network 110. It is possible to adopt various information processing apparatuses such as smartphones, tablet PCs, and note PCs as the portable device 122.

The portable device 122 captures printed matter that the image forming apparatuses 120a and 120b print and the document, transfers the captured image to the server 140, and instructs the server 140 to store the captured image. In addition, the portable device 122 requests the server 140 to identify printing colors and the scanning characteristic of the image forming apparatuses 120a and 120b and displays the identification result on a display unit of the portable device 122.

The server 140 is an information processing apparatus that identifies the printing colors and the scanning characteristic of the image forming apparatuses 120a and 120b. After receiving the request for identifying printing colors and the scanning characteristic of the image forming apparatuses 120a and 120b from the portable device 122, the server 140 identifies the printing colors and the scanning characteristic of the image forming apparatuses 120a and 120b using the scanned image received from the image forming apparatuses 120a and 120b and the captured image received from the portable device 122 and transfers the identification result to the portable device 122.

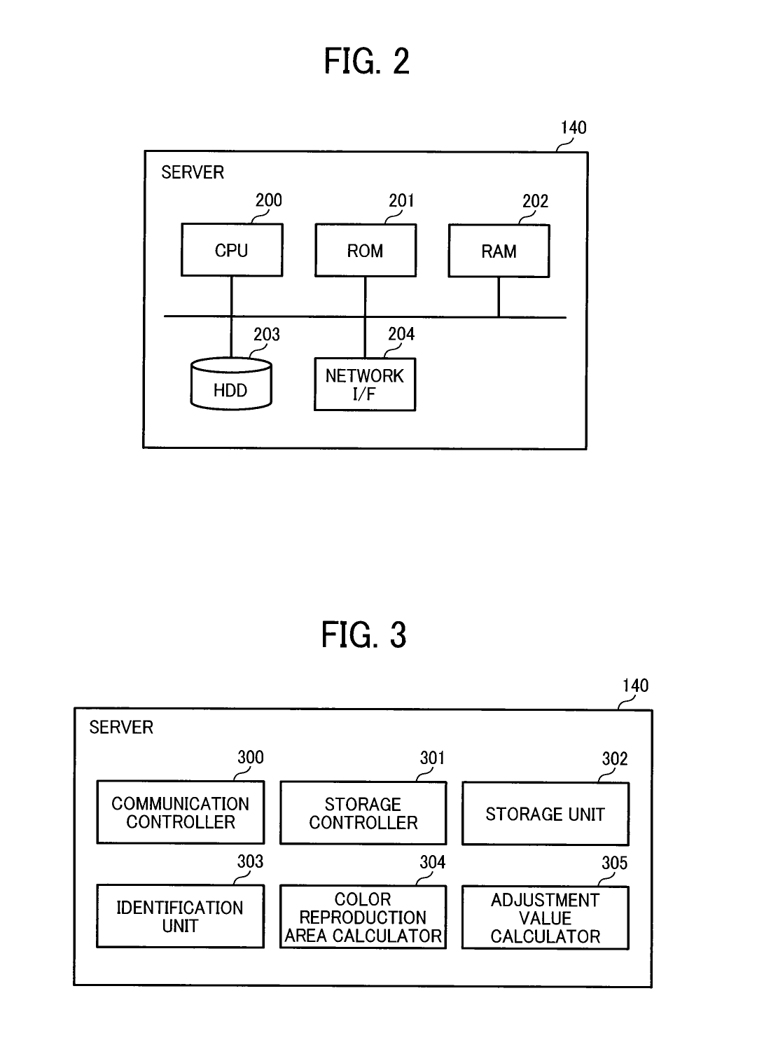

FIG. 2 is a diagram illustrating a hardware configuration of the server 140 in this embodiment. The hardware configuration of the server 140 is described below with reference to FIG. 2.

The server 140 includes a CPU 200, a ROM 201, a RAM 202, a HDD 203, and a network interface (I/F) 204.

The CPU 200 is a processor that controls operation of the server 140. The ROM 201 is a nonvolatile storage device that stores various data. The ROM 222 is a volatile storage device that provides working space for various programs that the server 140 executes. The network I/F 204 is a physical interface that enables to communicate via the networks 110 and 130. The HDD 203 is a storage device that can store various data such as a program in this embodiment sustainably. The CPU 200 implements functions (described later) on the server 140 by reading the program in this embodiment from the HDD 203, expanding the program into the RAM 202, and executing the program under the control of various operating systems (OSs).

Identification information of color materials, type information of the color materials, and color reproduction area of the color materials are associated with each other and registered in the HDD 203. The identification information of the color materials is identification of the known color materials that the image forming apparatuses 120a and 120b use. The type information of the color materials is information that indicates the types of the color materials (e.g., ink and toner etc.) that the image forming apparatuses 120a and 120b use. The color reproduction area information is information that indicates the color reproduction area of the image forming apparatuses 120a and 120b.

FIG. 3 is a diagram illustrating a functional configuration of the server 140 in FIG. 1 in this embodiment. The functions that the server 140 includes are described below with reference to FIG. 3.

The server 140 includes a communication controller 300, a storage controller 301, a storage unit 302, an identification unit 303, a color reproduction area calculator 304, and an adjustment value calculator 305.

The communication controller 300 controls communicating with the image forming apparatuses 120a and 120b and the portable device 122. The storage controller 301 controls the storage unit 302 that consists of the HDD 203, the ROM 201, and the RAM 202 in the server 140.

The communication controller 300 reports to the storage controller 301 upon receiving the scanned image and the captured image from the image forming apparatuses 120a and 120b and the portable device 122. The storage controller 301 stores these images in the storage unit 302.

The identification unit 303 identifies the printing colors and the scanning characteristic of the image forming apparatuses 120a and 120b using the color reproduction area calculator 304 and the adjustment value calculator 305. The color reproduction area calculator 304 calculates the color reproduction area of the image forming apparatuses 120a and 120b. The adjustment value calculator 305 calculates an adjustment value that equalizes the printing colors and the scanning characteristic of the image forming apparatuses 120a and 120b.

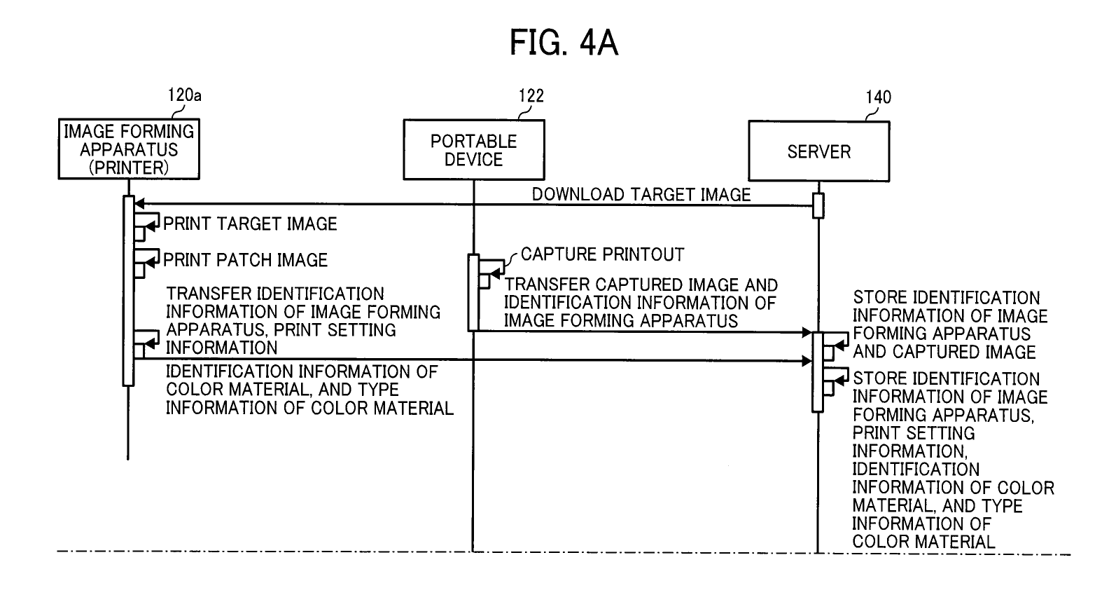

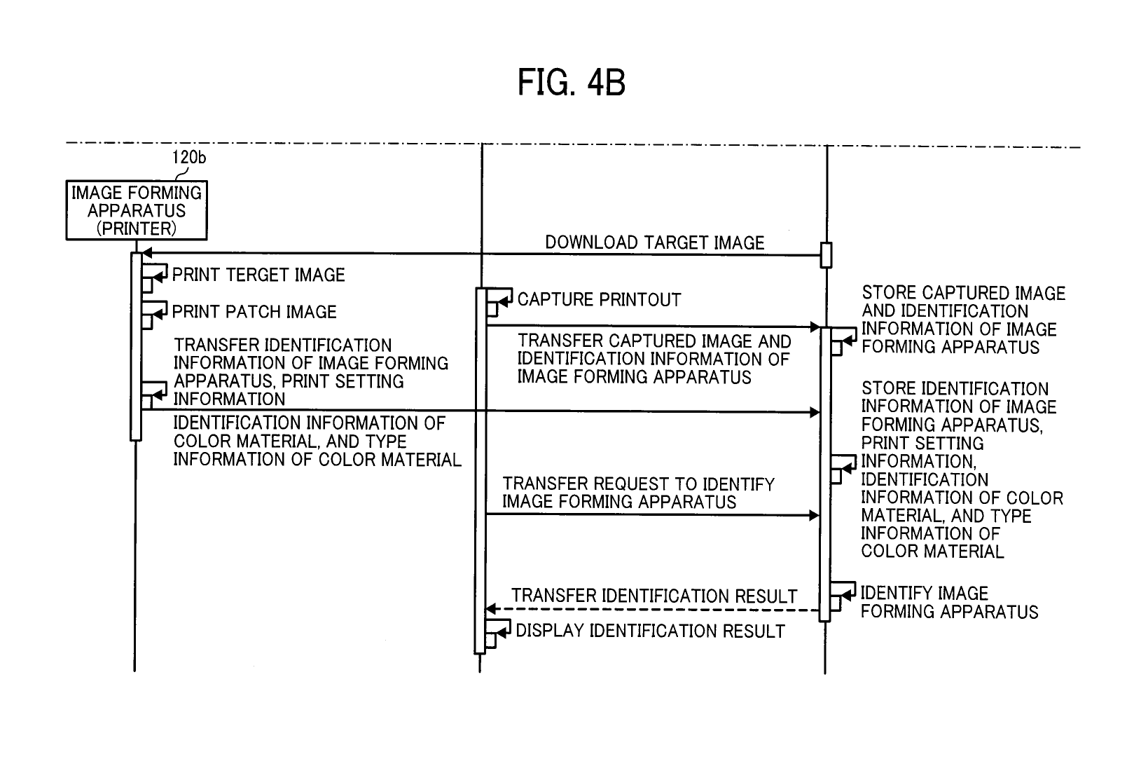

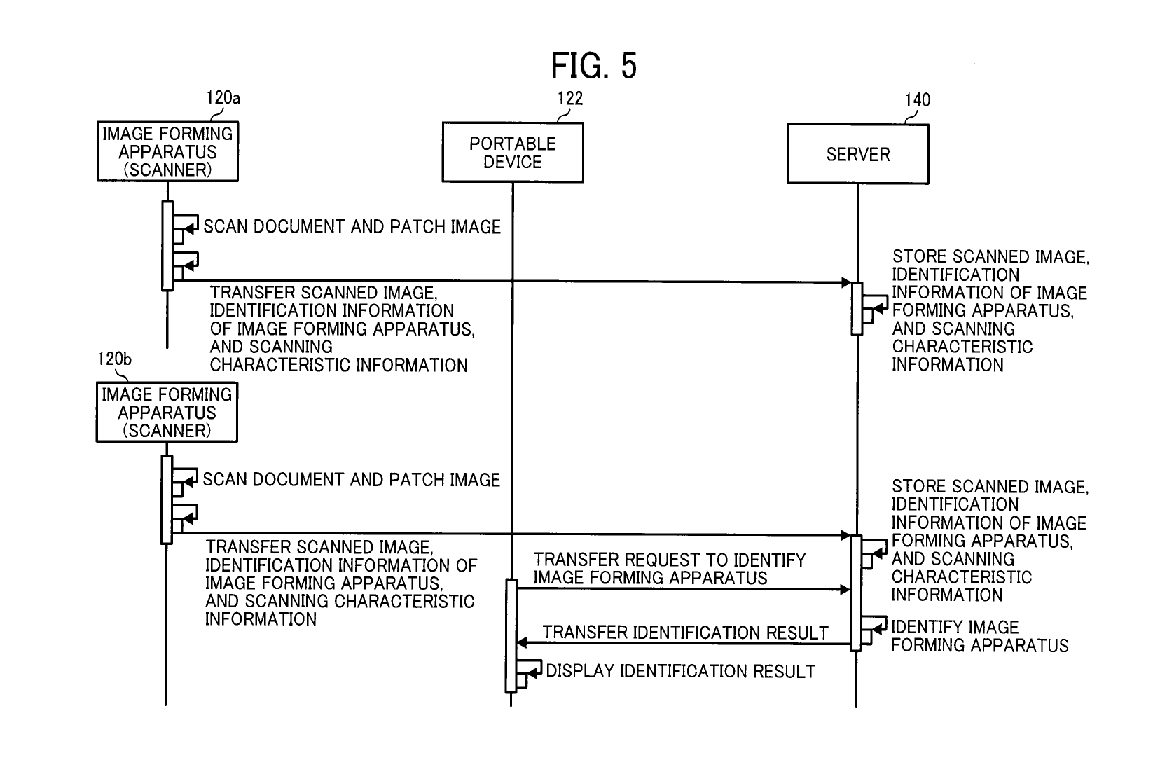

FIGS. 4A and 4B are sequence diagrams illustrating a process executed by the image processing system 100 in this embodiment. A process that replaces the image forming apparatus 120a as the printer with the image forming apparatus 120b as the printer and identifies the differences in the printing colors of those image forming apparatuses is described below with reference to FIGS. 4A and 4B.

First, before being replaced, the image forming apparatus 120a to be replaced downloads a target image from the server 140, prints the target image, and outputs the printed matter. Subsequently, the image forming apparatuses 120a and 120b print a patch image that includes unicolor patches in yellow (Y), magenta (M), cyan (C), and black (K). After that, the image forming apparatus 120a transfers the identification information of the image forming apparatus 120a, the print setting information used in printing the target image, and the identification information and the type information of the color materials that the image forming apparatus 120a uses to the server 140.

The portable device 122 captures the printed matter that the image forming apparatus 120a prints out, generates the captured image, and transfers the captured image and the identification information of the image forming apparatus 120a to the server 140. In this case, the portable device 122 transfers the captured image adding the identification information of the captured image that indicates the captured image of the target image or the captured image of the patch image to the captured image.

After receiving the captured image and the identification information of the image forming apparatus 120a from the portable device 122, the server 140 associates the captured image with the identification information of the image forming apparatus 120a and stores the captured image and the identification information of the image forming apparatus 120a in the storage unit 302. In addition, after receiving identification information of the image forming apparatus 120a, the print setting information, and the identification information and the type information of the color materials from the image forming apparatus 120b, the server 140 associates the information with each other and stores them in the storage unit 302.

Here, the image forming apparatus 120a is replaced with the image forming apparatus 120b by user operation. After being replaced the image forming apparatuses, the image forming apparatus 120b downloads the same image as the target image that the image forming apparatus 120a used from the server 140, prints the image, and outputs the printed matter.

Next, the image forming apparatus 120b prints the same patch image as the patch image that the image forming apparatus 120a used and outputs the printed matter. Subsequently, the image forming apparatus 120b transfers the identification information of the image forming apparatus 120b, the print setting information used in printing the target image, the identification information and the type information of the color materials that the image forming apparatus 120b uses, and the scanned image to the server 140.

The portable device 122 captures the printed matter that the image forming apparatus 120b prints out, generates the captured image, and transfers the captured image and the identification information of the image forming apparatus 120b to the server 140. In this case, the portable device 122 transfers the captured image adding the identification information of the captured image that indicates the captured image of the target image or the captured image of the patch image to the captured image.

After receiving the captured image and the identification information of the image forming apparatus 120b from the portable device 122, the server 140 associates the captured image with the identification information of the image forming apparatus 120b and stores the captured image and the identification information of the image forming apparatus 120b in the storage unit 302. In addition, after receiving identification information of the image forming apparatus 120b, the print setting information, and the identification information and the type information of the color materials from the image forming apparatus 120b, the server 140 associates the information with each other and stores them in the storage unit 302.

After specifying the image forming apparatuses 120a and 120b to be compared and instructing the portable device 122 to identify these image forming apparatuses by user operation, the portable device 122 transfers a request for identifying the image forming apparatuses 120a and 120b along with the identification information of the image forming apparatuses 120a and 120b and information on the type of the image forming apparatuses 120a and 120b (information that indicates that the image forming apparatuses are printers in this embodiment) to the server 140.

After receiving the request for identifying the image forming apparatuses 120a and 120b from the portable device 122, the server 140 identifies the difference in printing colors of the image forming apparatuses 120a and 120b using the captured image associated with the identification information of the image forming apparatuses 120a and 120b and transfers the identification result to the portable device 122. After receiving the identification result from the server 140, the portable device 122 displays the identification result on the display unit of the portable device 122.

In the embodiment shown in FIGS. 4A and 4B, the image forming apparatuses 120a and 120b transfer the print setting information and the color material identification and type to the server 140. However, in another embodiment, it is possible that the portable device 122 transfers this information along with the captured image. Alternatively, instead of the portable device 122, the image forming apparatus 120 may transfer the request to identify the image forming apparatuses 120a and 120b and display the identification result.

FIG. 5 is a sequence diagram illustrating a process executed by the image processing system 100 in another embodiment. A process that replaces the image forming apparatus 120a as the scanner with the image forming apparatus 120b as the scanner and identifies the differences in the scanning characteristics of those image forming apparatuses is described below with reference to FIG. 5.

First, before being replaced, the image forming apparatus 120a to be replaced generates the scanned image by scanning any document and the patch image and transfers the scanned image to the server 140 along with the identification information of the image forming apparatus 120a and scanning characteristic information that indicates spectral sensitivity of a scanning element and spectral intensity of a light source in the image forming apparatus 120a. In this case, the image forming apparatus 120a transfers the identification information of the scanned image that indicates the scanned image of the document or the scanned image of the patch image added to the scanned image.

After receiving the scanned image, the identification information and the scanning characteristic information of the image forming apparatus 120a from the image forming apparatus 120a, the server 140 associates the information with each other and stores them in the storage unit 302.

Here, in the embodiment shown in FIG. 5, the image forming apparatus 120a is replaced with the image forming apparatus 120b by user operation. After being replaced the image forming apparatuses, the image forming apparatus 120b scans the same document as the document that the image forming apparatus 120a scanned and the same patch image as the patch image that the image forming apparatus 120a scanned, generates the scanned image, and transfers the scanned image to the server 140 along with the identification information and the scanning characteristic information of the image forming apparatus 120b. In this case, the image forming apparatus 120b transfers the identification information of the scanned image that indicates the scanned image of the document or the scanned image of the patch image added to the scanned image.

After receiving the scanned image, the identification information and the scanning characteristic information of the image forming apparatus 120b from the image forming apparatus 120b, the server 140 associates the information with each other and stores them in the storage unit 302.

After specifying the image forming apparatuses 120a and 120b to be compared and instructing the portable device 122 to identify these image forming apparatuses by user operation, the portable device 122 transfers a request for identifying the image forming apparatuses 120a and 120b along with the identification information of the image forming apparatuses 120a and 120b and information on the type of the image forming apparatuses 120a and 120b (information that indicates that the image forming apparatuses are scanners in this embodiment) to the server 140.

After receiving the request for identifying the image forming apparatuses 120a and 120b from the portable device 122, the server 140 identifies the difference in scanning characteristics of the image forming apparatuses 120a and 120b using the captured image 2 0 associated with the identification information of the image forming apparatuses 120a and 120b and transfers the identification result to the portable device 122. After receiving the identification result from the server 140, the portable device 122 displays the identification result on the display unit of the portable device 122.

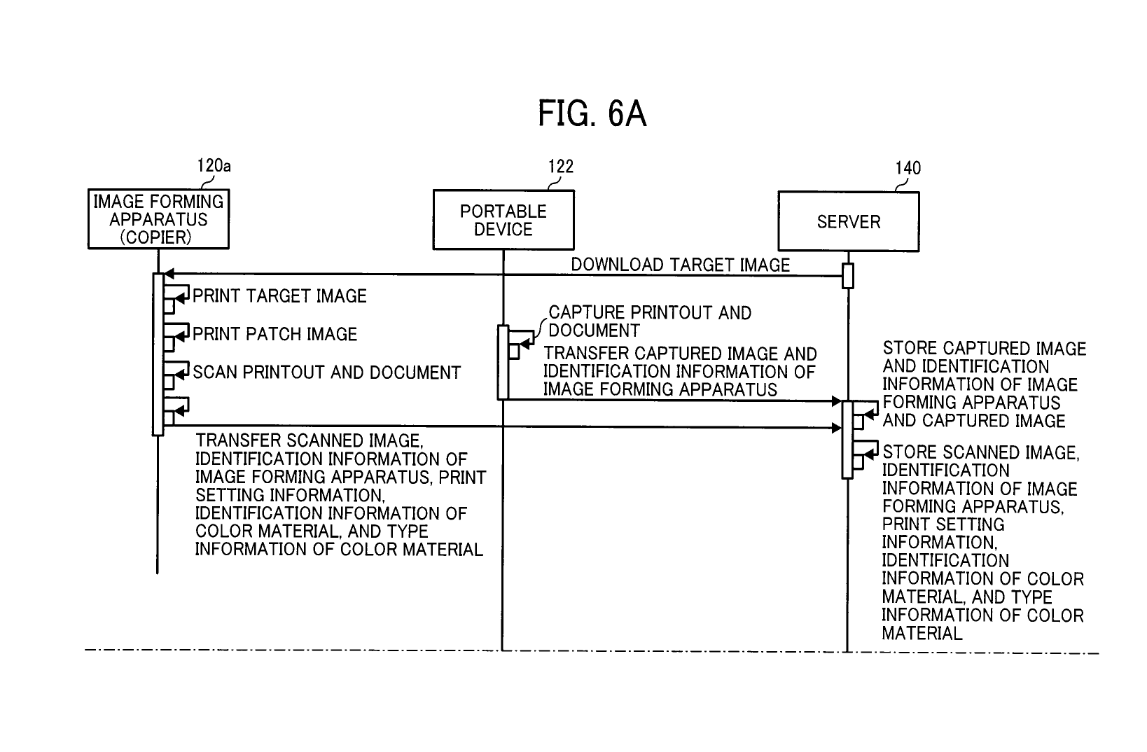

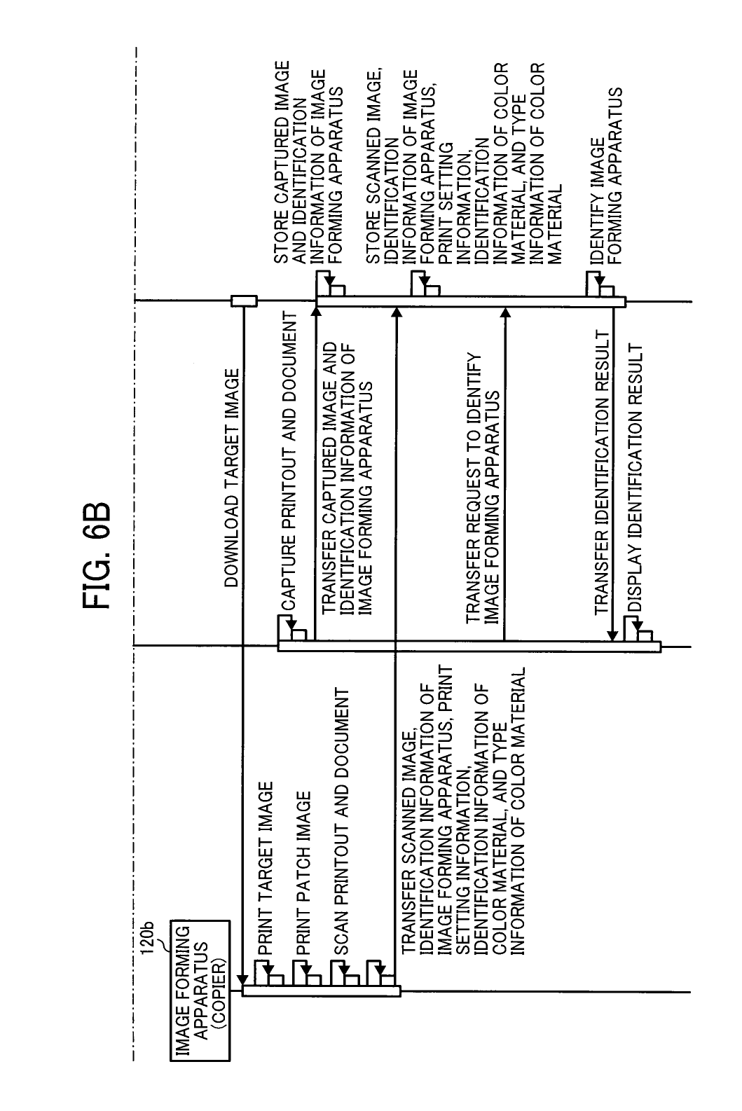

FIGS. 6A and 6B are sequence diagrams illustrating a process executed by the image processing system 100 in yet another embodiment. A process that replaces the image forming apparatus 120a as the MFP with the image forming apparatus 120b as the MFP and identifies the differences in the printing colors and the scanning characteristics of those image forming apparatuses is described below with reference to FIGS. 6A and 6B.

First, the image forming apparatus 120a to be replaced downloads a target image from the server 140, prints the target image, and outputs the printed matter. Subsequently, the image forming apparatus 120a prints the patch image, outputs the printed matter, and generates the scanned image by scanning the printed matter and the document. After that, the image forming apparatus 120a transfers the scanned image, the identification information of the image forming apparatus 120a, the print setting information used in printing the target image, and the identification information and the type information of the color material that the image forming apparatus 120a uses to the server 140. In this case, the image forming apparatus 120a adds to the scanned image the identification information of the scanned image that indicates the scanned image of the target image, the scanned image of the patch image, or the scanned image of the document and transmits the result.

The portable device 122 captures the printed matter that the image forming apparatus 120b generates and the document that the image forming apparatus 120a scans, generates the captured images, and transfers the captured images and the identification information of the image forming apparatus 120a to the server 140.

After receiving the captured images and the identification information of the image forming apparatus 120a from the portable device 122, the server 140 associates the captured images with the identification information of the image forming apparatus 120a and stores the captured images and the identification information of the image forming apparatus 120a in the storage unit 302. In addition, after receiving identification information of the image forming apparatus 120a, the print setting information, and the identification information and the type information of the color materials from the image forming apparatus 120b, the server 140 associates the information with each other and stores them in the storage unit 302.

Here, in the embodiment shown in FIGS. 6A and 6B, the image forming apparatus 120a is replaced with the image forming apparatus 120b by user operation. After being replaced the image forming apparatuses, the image forming apparatus 120b downloads the same target image as the target image that the image forming apparatus 120a used from the server 140, prints the target image, and outputs the printed matter.

Next, the image forming apparatus 120b prints the same patch image as the patch image that the image forming apparatus 120a used, outputs the printed matter, and generates the scanned image by scanning the printed matter and the document that the image forming apparatus 120a scanned. The image forming apparatus 120b transfers the scanned image, the identification information of the image forming apparatus 120b, the print setting information used in printing the target image, and the identification information and the type information of the color material that the image forming apparatus 120b uses to the server 140. In this case, the image forming apparatus 120b adds to the scanned image the identification information of the scanned image that indicates the scanned image of the target image, the scanned image of the patch image, or the scanned image of the document and transmits the result.

The portable device 122 captures the printed matter that the image forming apparatus 120b generated and the document that the image forming apparatus 120a scanned, generates the captured images, and transfers the captured images and the identification information of the image forming apparatus 120b to the server 140.

After receiving the captured image and the identification information of the image forming apparatus 120b from the portable device 122, the server 140 associates the captured image with the identification information of the image forming apparatus 120b and stores the captured image and the identification information of the image forming apparatus 120b in the storage unit 302. In addition, after receiving identification information of the image forming apparatus 120b, the print setting information, and the identification information and the type information of the color materials from the image forming apparatus 120b, the server 140 associates the information with each other and stores them in the storage unit 302.

After specifying the image forming apparatuses 120a and 120b to be compared and instructing the portable device 122 to identify these image forming apparatuses by user operation, the portable device 122 transfers a request for identifying the image forming apparatuses 120a and 120b along with the identification information of the image forming apparatuses 120a and 120b and information on the type of the image forming apparatuses 120a and 120b (information that indicates that the image forming apparatuses are MFPs in this embodiment) to the server 140.

After receiving the request for identifying the image forming apparatuses 120a and 120b from the portable device 122, the server 140 identifies the difference in scanning characteristics of the image forming apparatuses 120a and 120b using the scanned image and the captured image associated with the identification information of the image forming apparatuses 120a and 120b and transfers the identification result to the portable device 122. After receiving the identification result from the server 140, the portable device 122 displays the identification result on the display unit of the portable device 122.

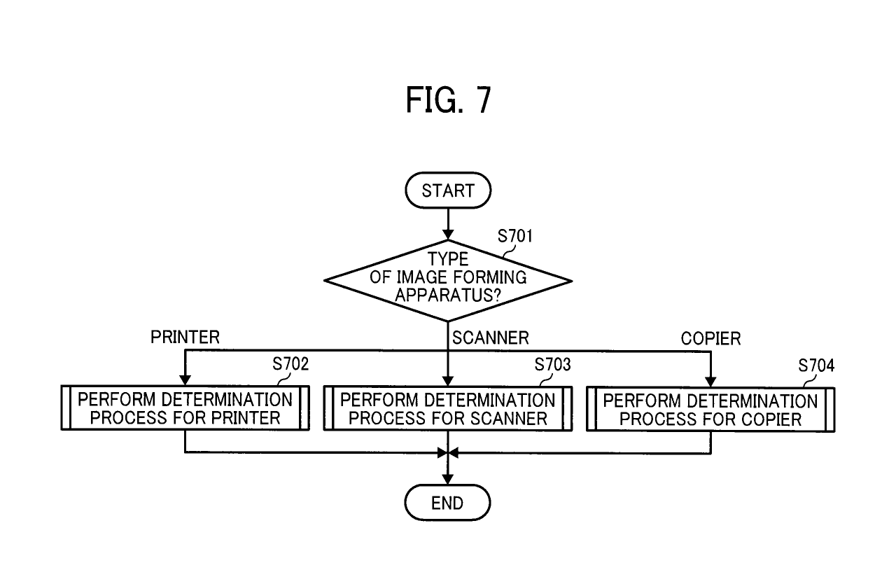

FIG. 7 is a flowchart illustrating a process executed by the server 140 in this embodiment. A process that the server 140 executes in case of receiving the request for identifying the image forming apparatus 120a and 120b is described below with reference to FIG. 7.

In FIG. 7, after starting the process, the identification unit 303 in the server 140 identifies the type of the image forming apparatuses 120a and 120b to be compared using the information that indicates the type of the image forming apparatuses 120a and 120b received with the request for the determination in S701, and the process branches in accordance with the type of the image forming apparatuses 120a and 120b.

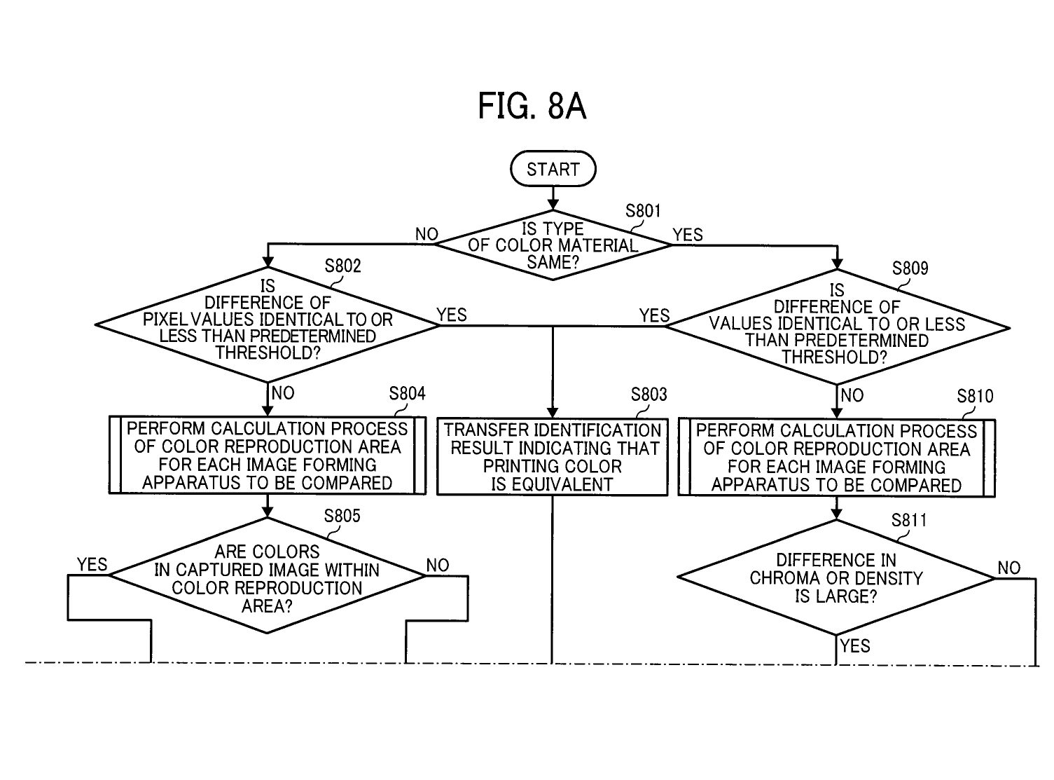

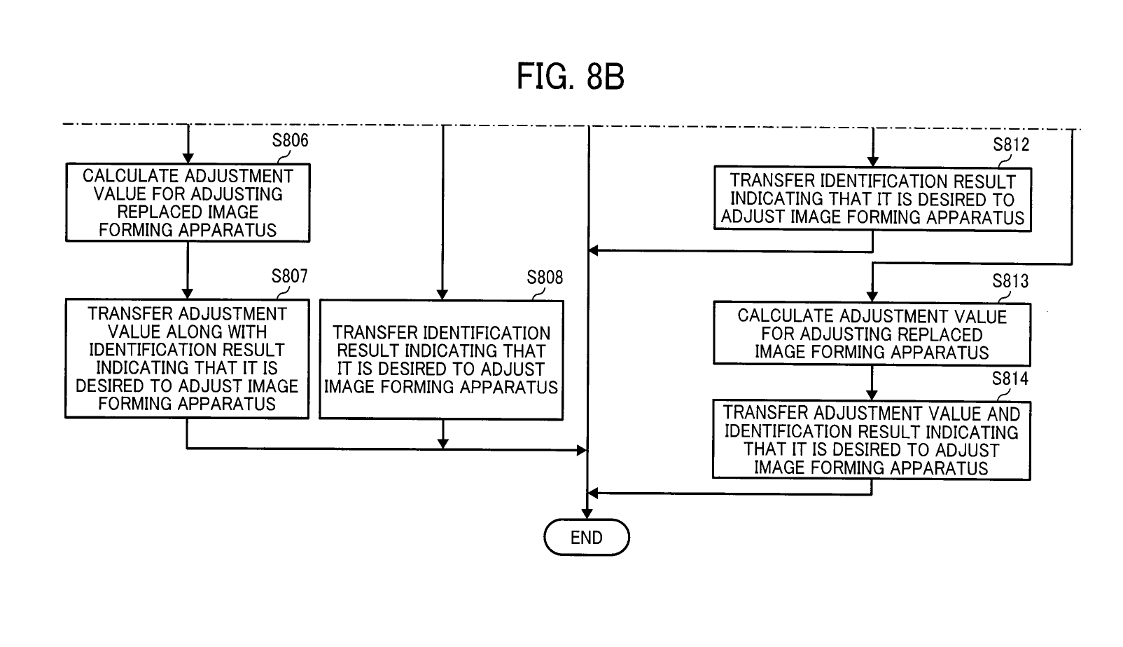

More specifically, if the image forming apparatuses 120a and 120b are printers, the identification unit 303 performs a determination process in FIGS. 8A and 8B to identify the difference in the printing colors of the printers in 5702, and the process ends.

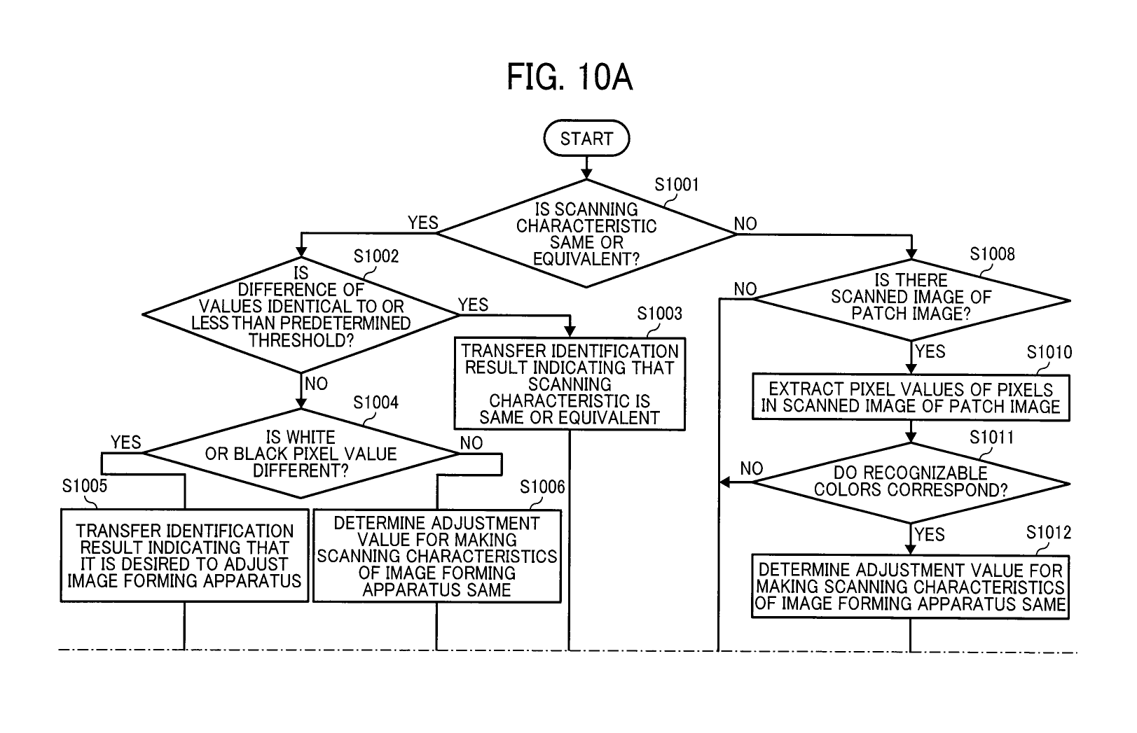

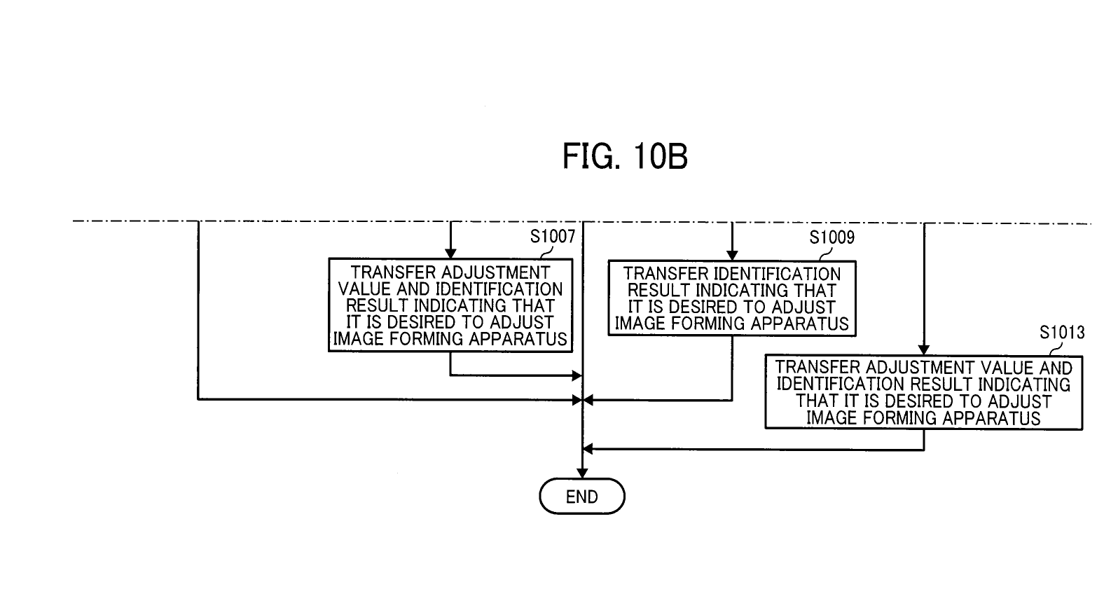

If the image forming apparatuses are scanners, the identification unit 303 performs a determination process in FIGS. 10A and 10B to identify the difference in the scanning characteristics of the scanners in 5703, and the process ends.

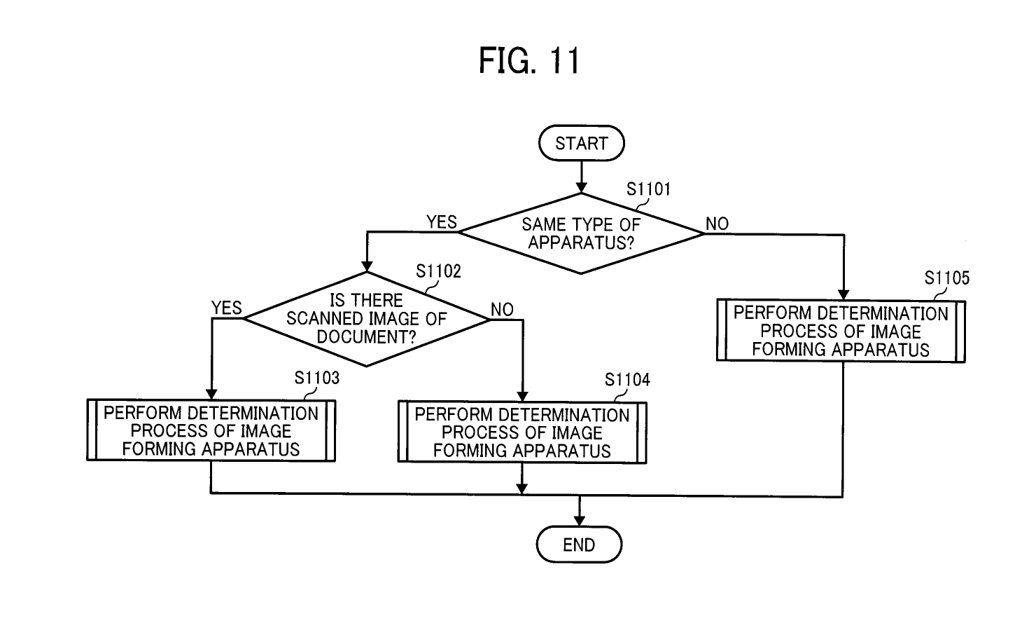

If the image forming apparatuses are MFPs, the identification unit 303 performs a determination process in FIG. 11 to identify the difference in the printing colors and the scanning characteristics of the MFPs in 5704, and the process ends.

FIGS. 8A and 8B are flowcharts illustrating a process of identifying a printer executed by the server 140 in this embodiment. In FIGS. 8A and 8B, after starting the process, the identification unit 303 acquires the type information of the color materials associated with the identification information of the image forming apparatuses 120a and 120b received with the request for the determination, i.e., the type information of the color materials that the image forming apparatuses 120a and 120b use from the storage unit 302 and identifies whether or not the type of the color materials that the image forming apparatuses 120a and 120b use is same in S801. If the color materials are different (NO in S801), the process branches to S802.

In S802, the identification unit 303 acquires the captured image associated with the identification information of the image forming apparatuses 120a and 120b from the storage unit 302, compares colors of pixels included in the captured images (RGB values), and identifies whether or not the differences of pixel values of the pixels are identical to or less than a predetermined threshold value. It is preferable to set the predetermined threshold value as an imperceptible difference.

In the embodiment in which the identification information of the color materials that the image forming apparatuses 120a and 120b use is stored in the storage unit 302, the identification unit 303 compares the captured images of the printed matter of the target image. By contrast, in the embodiment in which the identification information of the color materials that the image forming apparatuses 120a and 120b use is not stored in the storage unit 302, the identification unit 303 compares the captured images of the patch images.

If the differences of the pixel values of the pixels are identical to or less than the predetermined threshold (YES in S802), the process branches to S803. In S803, the identification unit 303 transfers the identification result indicating that the printing colors of the image forming apparatuses 120a and 120b are same or similar, and the process ends.

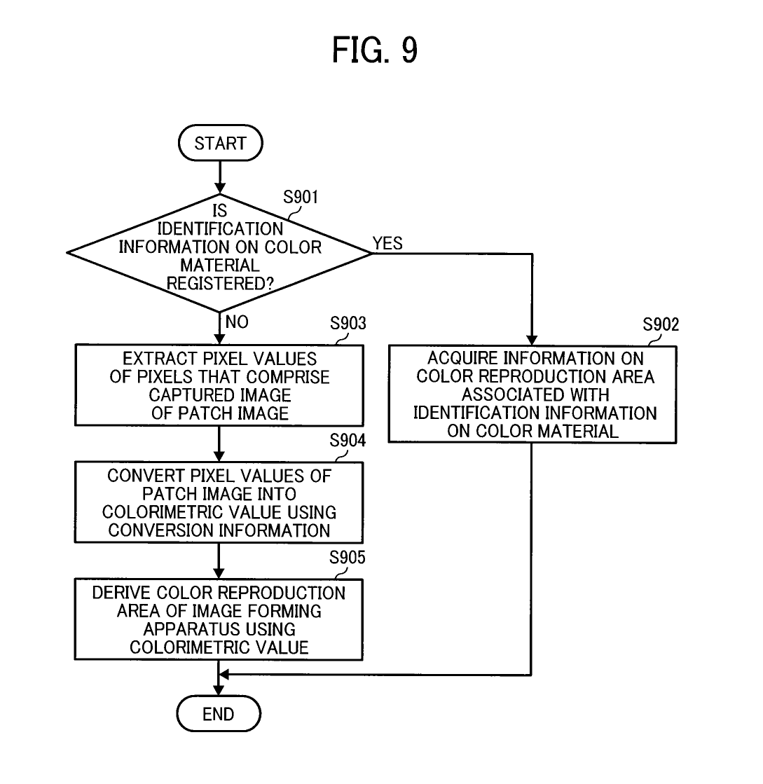

By contrast, if the difference of the pixel values of the pixels is larger than the predetermined threshold (NO in S802), the process branches to S804. In S804, the color reproduction area calculator 304 calculates a color reproduction area shown in FIG. 9 for each of the image forming apparatuses 120a and 120b to be compared.

In S805, the identification unit 303 identifies whether or not all colors of the pixels included in the captured image of the printed matter output by the image forming apparatus 120a before being replaced are within the color reproduction area of the image forming apparatus 120b after being replaced. If all colors in the captured image of the printed matter output by the image forming apparatus 120a before being replaced are within the color reproduction area of the image forming apparatus 120b after being replaced (YES in S805), that is, the image forming apparatus 120b after being replaced can express all colors that the image forming apparatus 120a before being replaced can express, the process branches to S806.

In S806, the adjustment value calculator 305 calculates an adjustment value that equalizes the printing colors of the image forming apparatus 120b after being replaced and the printing colors of the image forming apparatus 120a before being replaced. In S807, the identification unit 303 transfers the adjustment value calculated in S806 to the portable device 122 along with the identification result prompting adjustment of the image forming apparatus 120b, and the process ends.

By contrast, if any color n the captured image of the printed matter output by the image forming apparatus 120a before being replaced is out of the color reproduction area of the image forming apparatus 120b after being replaced (NO in S805), that is, the image forming apparatus 120b after being replaced cannot express colors that the image forming apparatus 120a before being replaced can express, the process branches to S808. In S808, the identification unit 303 transfers the identification result indicating that it is impossible to adjust the image forming apparatus 120b to the portable device 122, and the process ends.

By contrast, if the identification unit 303 identifies that the color materials that the image forming apparatuses 120a and 120b are same (YES in S801), the process branches to S809. In S809, the identification unit 303 acquires the captured image of the patch image associated with the identification information of the image forming apparatuses 120a and 120b from the storage unit 302, compares values that indicate lightness and brightness of the pixels included in the captured images, and identifies whether or not the differences in those values of the pixels are identical to or less than a predetermined threshold value. It is preferable that the predetermined threshold value be an imperceptible difference.

In other embodiments, it is possible that the identification unit 303 acquires the captured image of the printed matter of the target image associated with the identification information of the image forming apparatuses 120a and 120b from the storage unit 302, compares colors of pixels included in the captured images (RGB values), and identifies whether or not the differences of pixel values of the pixels are identical to or less than a predetermined threshold value.

If the differences in the pixel values of the pixels are identical to or less than the predetermined threshold (YES in S809), the process branches to S803. In S803, the identification unit 303 transfers the identification result indicating that the printing colors of the image forming apparatuses 120a and 120b are same or similar, and the process ends.

By contrast, if the difference of the pixel values of the pixels is larger than the predetermined threshold (NO in S809), the process branches to S810. In S810, the color reproduction area calculator 304 calculates a color reproduction area shown in FIG. 9 for each of the image forming apparatuses 120a and 120b to be compared.

In S811, the identification unit 303 calculates difference in chroma and density of the printing colors of the image forming apparatus 120a before being replaced and the image forming apparatus 120b after being replaced and identifies whether or not the difference in chroma and density in the printing colors is large. More specifically, if the chroma of the printing colors after being replaced is excessively low or high compared to the printing colors before being replaced, or the density of the printing colors after being replaced is excessively low or high compared to the printing colors before being replaced, the identification unit 303 identifies that the difference in the chroma or the density of the printing colors of the image forming apparatuses 120a and 120b is large (YES in S811), and the process branches to S812.

More specifically, the identification unit 303 subtracts the values that indicate the chroma of unicolor patches in yellow (Y), magenta (M), and cyan (C) included in the scanned image of the patch image printed out by the image forming apparatus 120b after being replaced from the values that indicate the chroma of unicolor patches in yellow (Y), magenta (M), and cyan (C) included in the scanned image of the patch image printed out by the image forming apparatus 120a before being replaced. If the difference in any color is larger than the predetermined threshold, that is, if the chroma of the printing colors of the image forming apparatus 120b after being replaced is excessively smaller than the chroma of the printing colors of the image forming apparatus 120a before being replaced, the identification unit 303 identifies that the difference in the chroma of the printing colors of the image forming apparatuses 120a and 120b is large. In this embodiment, a value that cannot resolve the difference in the chroma of the printing colors using an adjustment value calculated in S812

In addition, the identification unit 303 subtracts the values that indicate the chroma of unicolor patches in yellow (Y), magenta (M), and cyan (C) included in the scanned image of the patch image printed out by the image forming apparatus 120a before being replaced from the values that indicate the chroma of unicolor patches in yellow (Y), magenta (M), and cyan (C) included in the scanned image of the patch image printed out by the image forming apparatus 120b after being replaced. If the difference in any color is larger than the predetermined threshold, that is, if the chroma of the printing colors of the image forming apparatus 120b after being replaced is excessively larger than the chroma of the printing colors of the image forming apparatus 120a before being replaced, the identification unit 303 identifies that the difference in the chroma of the printing colors of the image forming apparatuses 120a and 120b is large.

Furthermore, the identification unit 303 subtracts the values that indicate the density of unicolor patches in yellow (Y), magenta (M), and cyan (C) included in the scanned image of the patch image printed out by the image forming apparatus 120b after being replaced from the values that indicate the density of unicolor patches in yellow (Y), magenta (M), and cyan (C) included in the scanned image of the patch image printed out by the image forming apparatus 120a before being replaced. If the difference in any color is larger than the predetermined threshold, that is, if the density of the printing colors of the image forming apparatus 120b after being replaced is excessively lower than the density of the printing colors of the image forming apparatus 120a before being replaced, the identification unit 303 identifies that the difference in the density of the printing colors of the image forming apparatuses 120a and 120b is large. In this embodiment, a value that cannot resolve the difference in the density of the printing colors using an adjustment value calculated in S812 (described later) is adopted as the predetermined threshold.

Furthermore, the identification unit 303 subtracts the values that indicate the density of unicolor patches in yellow (Y), magenta (M), and cyan (C) included in the scanned image of the patch image printed out by the image forming apparatus 120a before being replaced from the values that indicate the density of unicolor patches in yellow (Y), magenta (M), and cyan (C) included in the scanned image of the patch image printed out by the image forming apparatus 120b after being replaced. If the difference in any color is larger than the predetermined threshold, that is, if the density of the printing colors of the image forming apparatus 120b after being replaced is excessively higher than the density of the printing colors of the image forming apparatus 120a before being replaced, the identification unit 303 identifies that the difference in the density of the printing colors of the image forming apparatuses 120a and 120b is large.

In S812, the identification unit 303 transfers the identification result prompting adjustment of the chroma or the density of the image forming apparatus 120b to the portable device 122, and the process ends. In this case, the identification unit 303 transfers the identification result indicating that it is desired to set the chroma of the printing colors of the image forming apparatus 120b high or low, or it is desired to set the density of the printing colors of the image forming apparatus 120b high or low.

By contrast, if it is determined that the difference in the chroma or the density of the printing colors of the image forming apparatus 120b after being replaced is not large (NO in S811), the process branches to S813. In S813, the adjustment value calculator 305 calculates an adjustment value that equalizes the printing colors of the image forming apparatus 120b after being replaced and the printing colors of the image forming apparatus 120a before being replaced. In S814, the identification unit 303 transfers the adjustment value calculated in S806 to the portable device 122 along with the identification result prompting adjustment of the image forming apparatus 120b, and the process ends.

FIG. 9 is a flowchart illustrating a process of calculating the color reproduction area executed by the server 140 in this embodiment. In FIG. 9, after starting the process, the color reproduction area calculator 304 identifies whether or not the identification information of the color materials that the image forming apparatuses 120a and 120b use is registered in the storage unit 302 in S901. If the identification information of the color materials is registered (YES in S901), the color reproduction area calculator 304 acquires the registered color reproduction area information associated with the identification information of the color materials in S902, and the process ends.

By contrast, if the identification information of the color materials is not registered (NO in S901), the color reproduction area calculator 304 extracts the pixel values of the pixels (RGB values) included in the captured image of the patch image of the image forming apparatuses 120a and 120b in S903. In S904, the color reproduction area calculator 304 converts the pixel values of the pixels included in the captured image of the patch image into colorimetric values using conversion information that converts the pixel values (RGB values) into the colorimetric values (Lab values). In S905, the color reproduction area calculator 304 calculates the color reproduction area of the image forming apparatuses 120a and 120b using the colorimetric values of the pixels included in the captured image of the patch image, and the process ends.

FIGS. 10A and 10B are flowcharts illustrating a process of identifying a scanner executed by the server 140 in this embodiment. In FIGS. 10A and 10B, after starting the process, the identification unit 303 acquires the scanning characteristic information associated with the identification information of the image forming apparatuses 120a and 120b that the portable device 122 transfers from the storage unit 302 and identifies whether or not the scanning characteristics of the image forming apparatus 120a before being replaced and the image forming apparatus 120b after being replaced are identical or similar in S1001. If the scanning characteristics of the image forming apparatuses 120a and 120b are identical or similar (YES in S1001), the process branches to S1002.

In S1002, the identification unit 303 acquires the captured image of the patch image associated with the identification information of the image forming apparatuses 120a and 120b from the storage unit 302, compares values that indicate lightness and brightness of the pixels included in the captured images, and identifies whether or not the differences in those values of the pixels are identical to or less than a predetermined threshold value. It is preferable to set the predetermined threshold value as an imperceptible difference.

In other embodiments, it is possible that the identification unit 303 acquires the scanned images of the document associated with the identification information of the image forming apparatuses 120a and 120b from the storage unit 302, compares colors of pixels included in the scanned images (RGB values), and identifies whether or not the differences of pixel values of the pixels are identical to or less than a predetermined threshold value.

If the differences in the pixel values of the pixels are identical to or less than the predetermined threshold (YES in S1002), the process branches to S1003. In S1003, the identification unit 303 transfers the identification result indicating that the scanning characteristics of the image forming apparatus 120a before being replaced and the image forming apparatus 120b after being replaced are identical or similar to the portable device 122, and the process ends.

By contrast, if the differences of the pixel values of the pixels are larger than the predetermined threshold (NO in S1002), the process branches to S1004. In S1004, the identification unit 303 identifies whether or not the pixel values in white areas or black areas included in the scanned image by the image forming apparatus 120a before being replaced are different from the pixel values in white areas or black areas included in the scanned image by the image forming apparatus 120b after being replaced.

If the pixel values in the white areas or the black area are different (YES in S1004), the process branches to S1005. In S1005, the identification unit 303 transfers the identification result prompting adjustment of the image forming apparatus 120b to the portable device 122, and the process ends. In this case, light amounts of the light source or gain etc. in the image forming apparatus 120b is adjusted by user operation. By contrast, if the pixel values in the white areas or the black area are identical (NO in S1004), the process branches to S1006. In S1006, the adjustment value calculator 305 identifies the adjustment value that equalizes the scanning characteristic of the image forming apparatus 120b after being replaced and the scanning characteristic of the image forming apparatus 120a before being replaced.

In this embodiment, the server 140 stores adjustment value determination information that associates the difference in the scanned values with the adjustment value of the image forming apparatus 120a (e.g., light amounts of the lamp and the gain of the A/D converter etc.), and the adjustment value calculator 305 identifies the adjustment value associated with the difference in the scanned valued calculated in S1002 by referring to the adjustment value determination information.

In another embodiment, it is possible that the server 140 stores adjustment value determination information that associates the difference in the scanned values with a direction of the adjustment value that corrects the difference in the scanned values (plus side or minus side), and the adjustment value calculator 305 identifies the direction of the adjustment value associated with the difference in the scanned values calculated in S1002 by referring to the adjustment value determination information.

In S1007, the identification unit 303 transfers the adjustment value calculated in S1006 to the portable device 122 along with the identification result prompting adjustment of the image forming apparatus 120b, and the process ends.

By contrast, if it is determined that the scanning characteristics of the image forming apparatus 120a before being replaced and the image forming apparatus 120b after being replaced are different or at least any one of the scanning characteristic information of the image forming apparatus 120a and the image forming apparatus 120b is not stored in the storage unit 302 (NO in S1001), the process branches to S1008. In S1008, the identification unit 303 identifies whether or not the scanned images of the patch image associated with the identification information of the image forming apparatuses 120a and 120b to be compared that the portable device 122 transferred are stored in the storage unit 302.

If the scanned images of the patch image are not stored (NO in S1008), the process branches to S1009. In S1009, the identification unit 303 transfers the identification result indicating that it is impossible to adjust the image forming apparatus 120b to the portable device 122, and the process ends.

By contrast, if the scanned images of the patch images are stored (YES in S1008), the process branches to S1010. In S1010, the identification unit 303 extracts the pixel values of the pixels included in the scanned images of the patch images of the image forming apparatus 120a before being replaced and the image forming apparatus 120b after being replaced. In S1011, the identification unit 303 identifies whether or not identifiable colors of the image forming apparatus 120a before being replaced corresponds with identifiable colors of the image forming apparatus 120b after being replaced.

More specifically, assuming RGB scanned values of the image forming apparatus before being replaced as (Rb1, Gb1, Bb1) and (Rb2, Gb2, Bb2) for the same patches 1 and 2, and RGB scanned values of the image forming apparatus after being replaced as (Ra1, Ga1, Ba1) and (Ra1, Ga2, Ba2) for the same patches 1 and 2, it is determined that the patch 1 and the patch 2 are identifiable if (Rb1−Rb2) equals (Ra1−Ra2), (Gb1−Gb2) equals (Ga1−Ga2), and (Bb1−Bb2) equals (Ba1−Ba2).

Practically, depending on characteristic of reflectance and absolute values of (Rb1, Gb1, Bb1) and (Ra1, Ga1, Ba1), regarding the scanned values of the scanner (RGB), assuming Rb1>Ra1 for the R component, it is determined that the patch 1 and the patch 2 are identifiable equivalently in case of (Rb1−Rb2)>(Ra1−Ra2)>0. Much the same is true on the G component (e.g., Gb1 and Ga1 etc.) and the B component (e.g., Bb1 and Ba1 etc.).

By contrast, assuming that |A| is an absolute value of A, for example, in case of |(Rb1−Rb2)|>|(Ra1−Ra2)|=0, (Gb1−Gb2)=(Ga1−Ga2), and (Bb1−Bb2)=(Ba1−Ba2), it is determined that the identifiable colors of the image forming apparatus before being replaced (scanner) become unidentifiable colors of the image forming apparatus after being replaced.

The determination described above is performed for all combinations of the patches. It is possible to identify that which hue patch is easy to be identified or difficult to be identified in hue (e.g., RGBCMY) from the relationship among the colorimetric value of the patch 1 L1*a1*B1*, the colorimetric value of the patch 2 L2*a2*B2*, and the scanned values of the scanner (RGB).

If the identifiable colors of the image forming apparatuses 120a and 120b do not correspond (NO in S1011), the process branches to S1009. By contrast, if the identifiable colors of the image forming apparatuses 120a and 120b correspond (YES in S1011), the process branches to S1012. In S1012, just the same as in S1006, the adjustment value calculator 305 identifies the adjustment value that equalizes the scanning characteristic of the image forming apparatus 120b after being replaced and the scanning characteristic of the image forming apparatus 120a before being replaced using the pixel values extracted in S1010.

In S1013, the identification unit 303 transfers the adjustment value calculated in S1012 to the portable device 122 along with the identification result prompting adjustment of the image forming apparatus 120b, and the process ends.

In this embodiment, if it is impossible to make the scanning characteristic identical or similar even in case of adjusting the image forming apparatus 120a using the adjustment value determined in S1012 by user operation, it is possible to utilize the conventional technology and equalize the scanned values and the characteristic of image data after processing the image.

More specifically, by utilizing a linear masking processor and a three-dimensional LUT converter described in the conventional technology, image processing parameters set to the linear masking processor and the three-dimensional LUT converter are determined. Since the scanning characteristics of the scanners are different, values input to the linear masking process are different. If any patch 1 and any patch 2 are identifiable, it is possible to bring the output results by the three-dimensional LUT converter close to equal.

Assuming the scanned value by the image processing apparatus (scanner) before being replaced as scanned value 1 and the scanned value by the image processing apparatus (scanner) after being replaced as scanned value 2, it is possible to identify the linear masking process parameter (adjustment value) by applying the scanned value 2 to the linear masking processor and determine the three-dimensional LUT conversion parameter (adjustment value) by applying the scanned value 1 to the three-dimensional LUT converter.

The linear masking process parameters are used for coarse adjustment and adjusting whole amounts (e.g., ratio of density, brightness, and colors), and the three-dimensional LUT conversion parameters are used for fine adjustment (e.g., adjustment of hue on near colors). If the scanned value 1 is near to the scanned value 2, only either one of the linear masking process parameter or the three-dimensional LUT conversion parameter is adjusted.

FIG. 11 is a flowchart illustrating a process of identifying a multifunction peripheral (MFP) executed by the server 140 in this embodiment. In FIG. 11, after starting the process, the identification unit 303 identifies whether or not types of the image forming apparatuses 120a and 120b are same. In this embodiment, if the product names included in the identification information of the image forming apparatuses 120a and 120b are same, the identification unit 303 identifies that the type of these image forming apparatuses is same.

If the type of the image forming apparatuses 120a and 120b is same (YES in S1101), the process branches to S1102. In S1102, the identification unit 303 identifies whether or not the storage unit 302 stores the scanned images of documents by both the image forming apparatuses 120a and 120b by referring to the identification information of the scanned image added to the scanned image associated with the identification information of the image forming apparatus that the portable device 122 transfers.

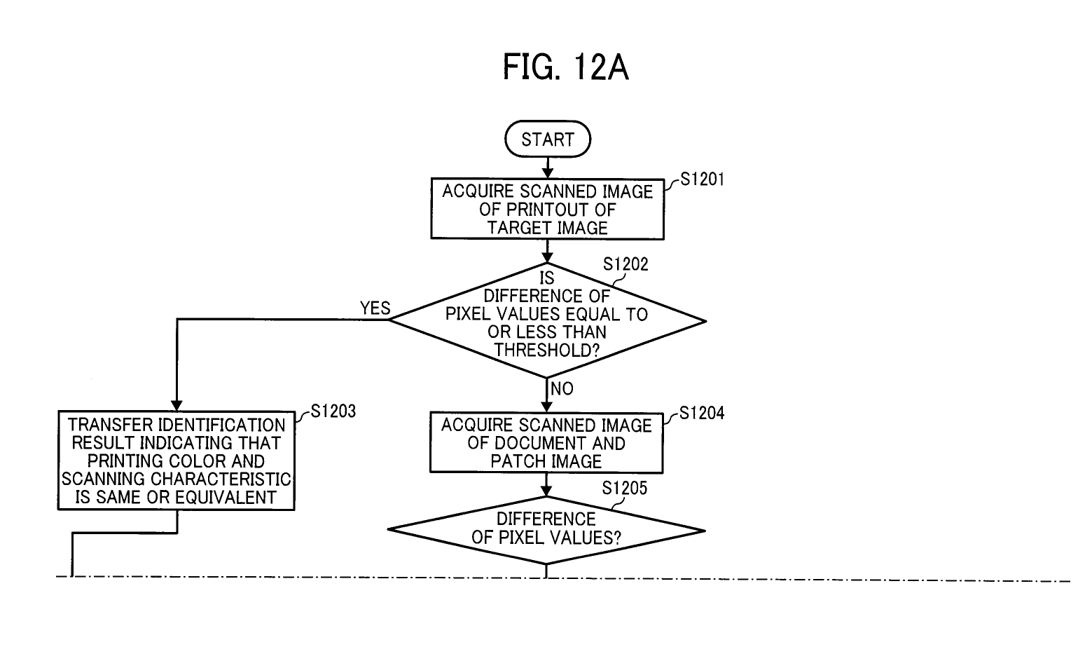

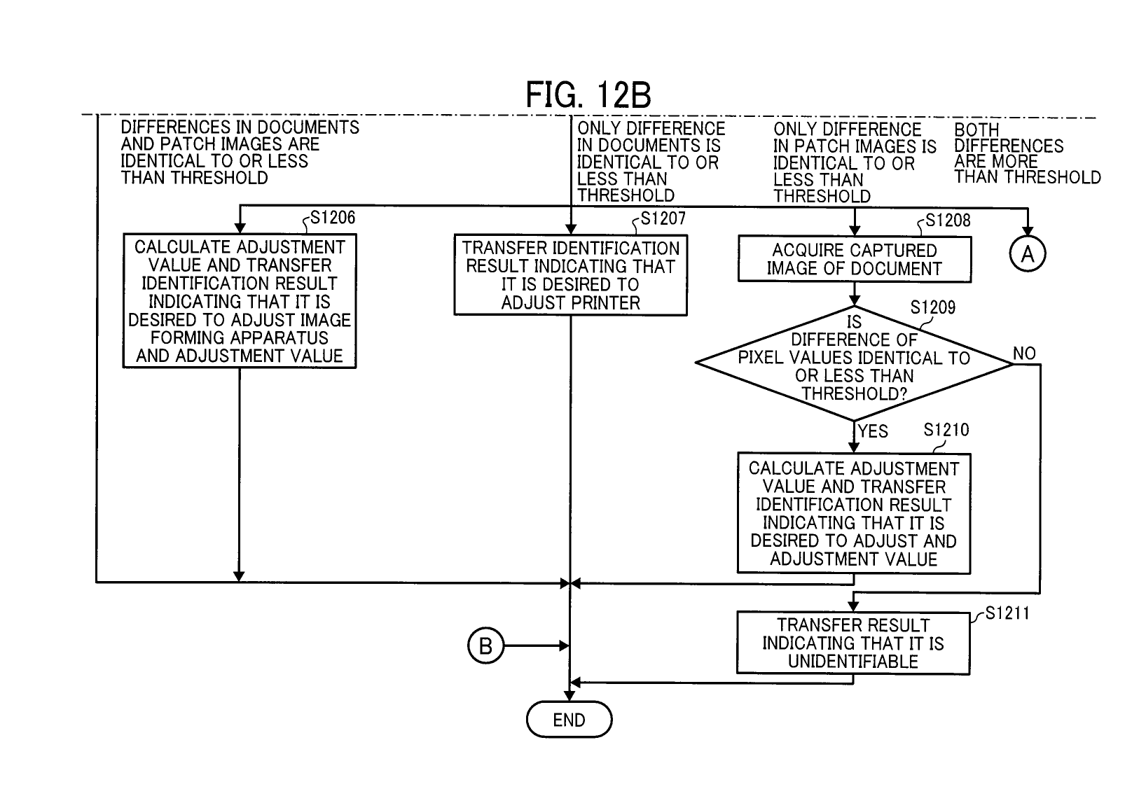

If there are scanned images of documents by both the image forming apparatuses 120a and 120b (YES in S1102), the process branches to S1103. In S1103, the identification unit 303 executes the determination process of the printing colors and the scanning characteristics of the image forming apparatus shown in FIGS. 12A and 12B, and the process ends.

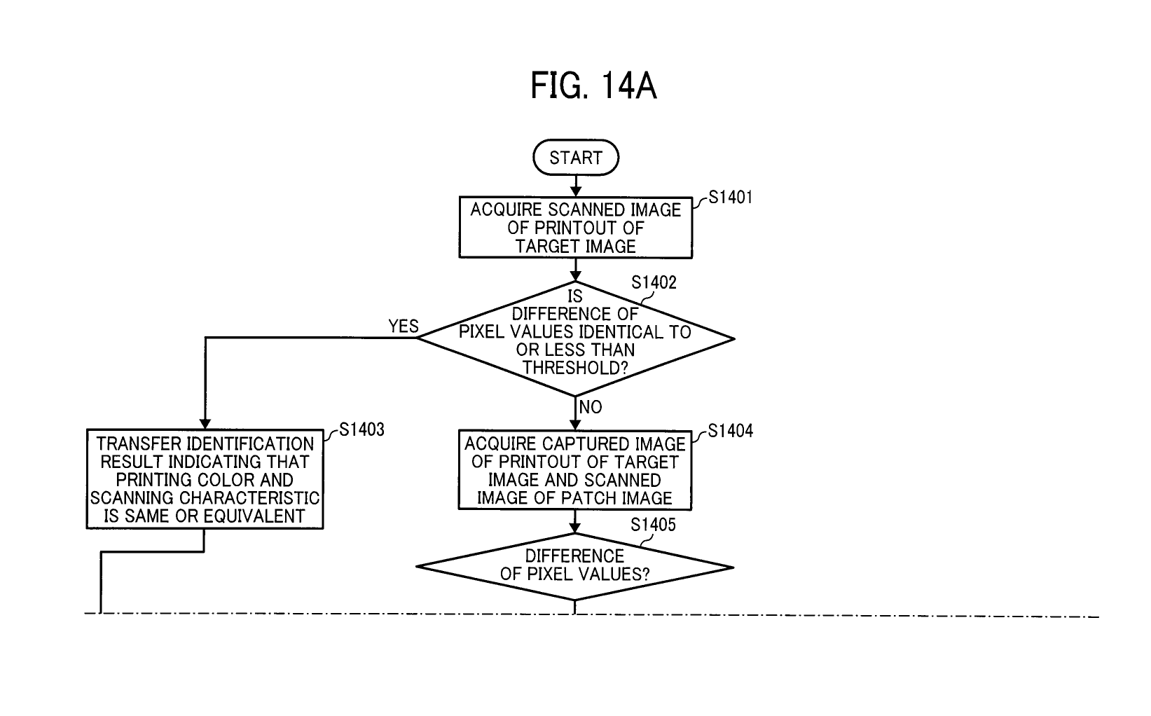

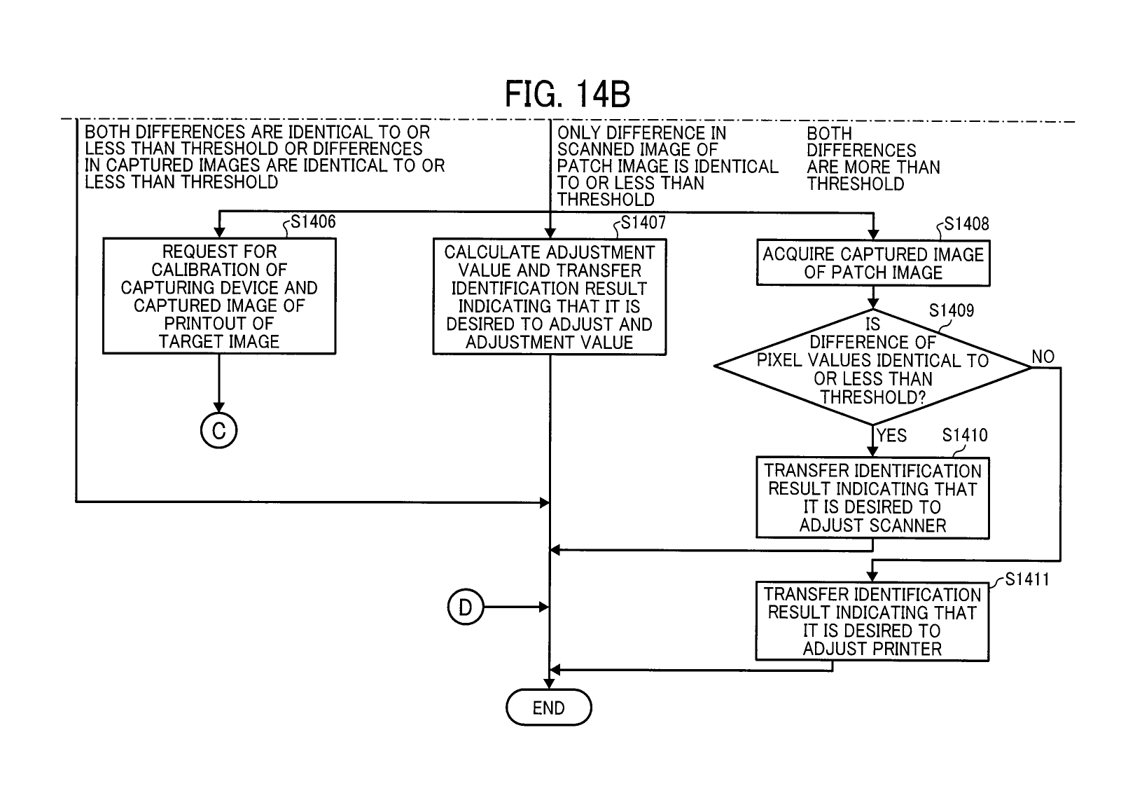

If at least one of the scanned image of documents by the image forming apparatus 120a and the scanned image of documents by the image forming apparatus 120b does not exist (NO in S1102), the process branches to S1104. In S1104, the identification unit 303 executes the determination process of the printing colors and the scanning characteristics of the image forming apparatus shown in FIGS. 14A and 14B, and the process ends.

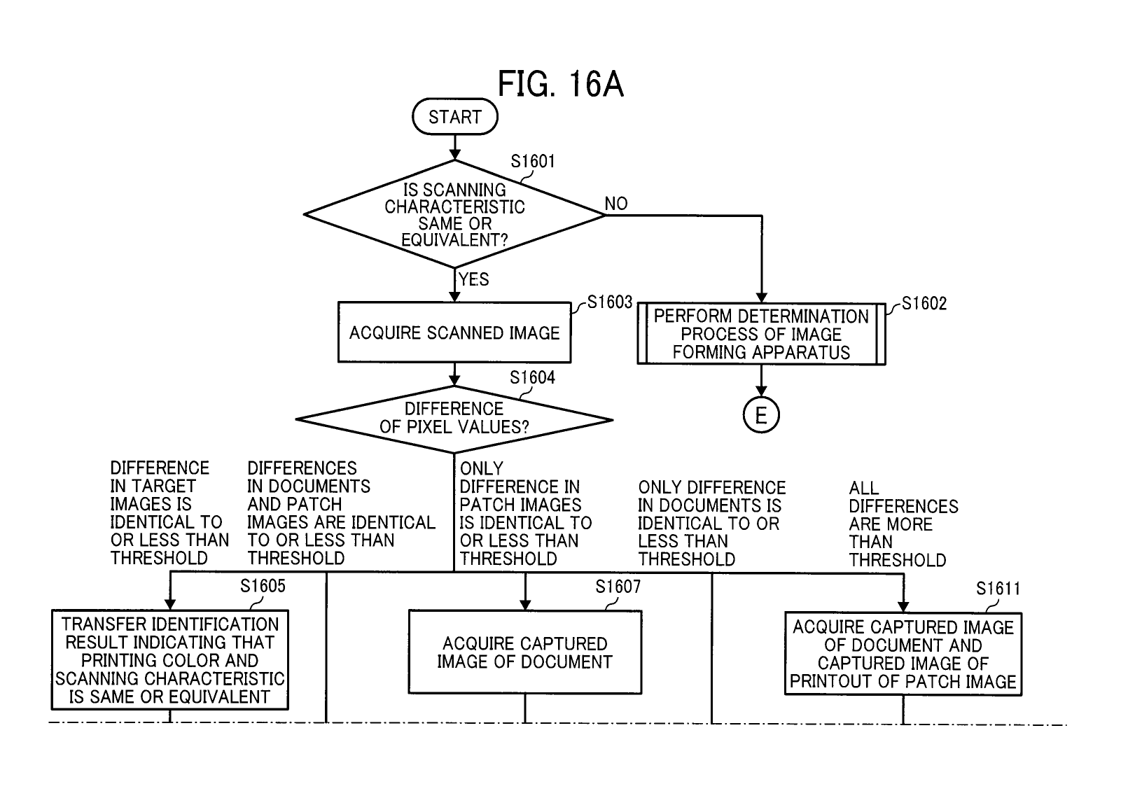

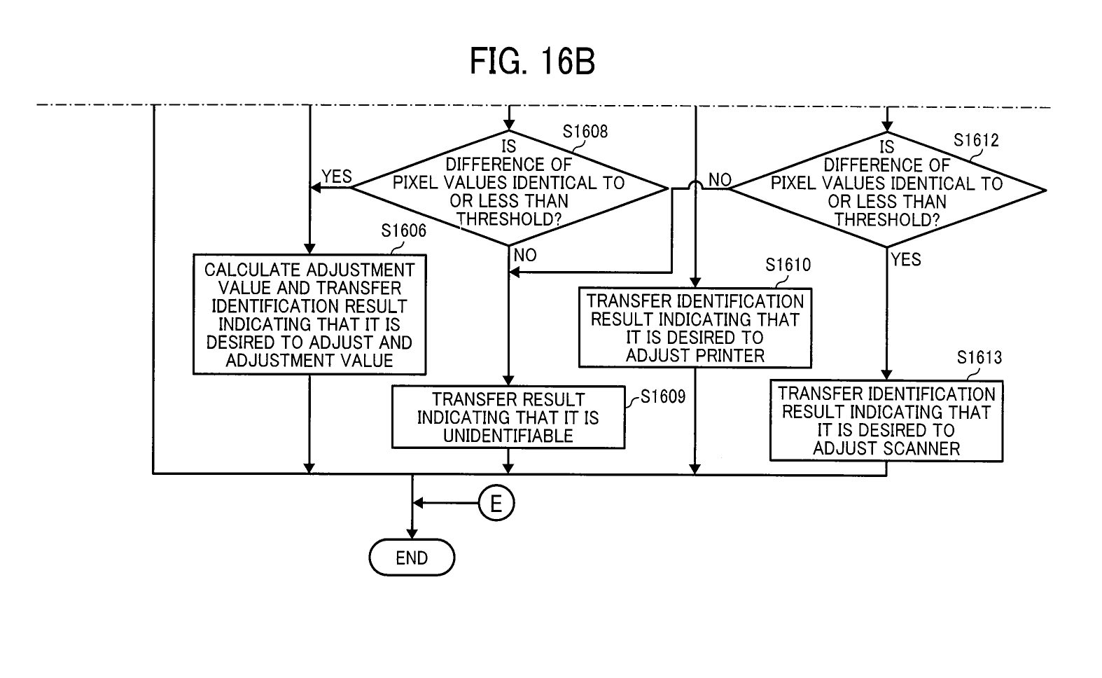

By contrast, if the identification unit 303 identifies that the types of the image forming apparatuses 120a and 120b are different (NO in S1101), the process branches to S1105. In S1105, the identification unit 303 executes the determination process of the printing colors and the scanning characteristics of the image forming apparatus shown in FIGS. 16A and 16B, and the process ends. In this embodiment, if the types of the image forming apparatuses 120a and 120b are different, the scanned images of the document are stored in the server 140.

FIGS. 12A and 12B are flowcharts illustrating a process of identifying an image forming apparatus executed by the server 140 if the image forming apparatuses to be compared are same type of MFPs and a scanned image of a document exists in this embodiment.

In FIGS. 12A and 12B, the process starts after executing S1103 shown in FIG. 11. In S1201, the identification unit 303 acquires the scanned image of the printed matter of the target image associated with the identification information of the image forming apparatuses 120a and 120b that the portable device 122 transfers from the storage unit 302.

In S1202, the identification unit 303 identifies whether or not differences between the pixel values of pixels (RGB values) included in the scanned image of the image forming apparatus 120a before being replaced and the pixel values of pixels (RGB values) included in the scanned image of the image forming apparatus 120b after being replaced are identical to or less than a predetermined threshold. In this embodiment, it is preferable to adopt the difference in the pixel values unrecognizable by the naked eye as the predetermined threshold.

If the differences in the pixel values are identical to or less than the predetermined threshold (YES in S1202), the process branches to S1203. In S1203, the identification unit 303 transfers the identification result indicating that the printing colors and the scanning characteristics of the image forming apparatus 120a before being replaced and the image forming apparatus 120b after being replaced are identical or similar to the portable device 122, and the process ends.

By contrast, if the differences of the pixel values of the pixels are larger than the predetermined threshold (NO in S1202), the process branches to S1204. In S1204, the identification unit 303 acquires the scanned image of the printed matter of the documents and the patch images associated with the identification information of the image forming apparatuses 120a and 120b to be compared that the portable device 122 transfers from the storage unit 302.

In S1205, the identification unit 303 identifies whether or not differences between the pixel values of pixels (RGB values) included in the scanned image of the documents of the image forming apparatus 120a before being replaced and the pixel values of pixels (RGB values) included in the scanned images of the documents of the image forming apparatus 120b after being replaced are identical to or less than a predetermined threshold, and the identification unit 303 identifies whether or not differences between the pixel values of pixels (RGB values) included in the scanned images of the printed matter of the patch images of the image forming apparatus 120a before being replaced and the pixel values of pixels (RGB values) included in the scanned images of the printed matter of the patch images of the image forming apparatus 120b after being replaced are identical to or less than a predetermined threshold. Subsequently, the process branches in accordance with the identification result. In this embodiment, it is preferable to adopt the difference in the pixel values unrecognizable by the naked eye as the predetermined threshold.

More specifically, if the differences in the pixel values of the scanned images of the documents are identical to or less than the predetermined threshold and the differences in the pixel values of the scanned images of the printed matter of the patch images are identical to or less than the predetermined threshold, the process branches to S1206. In S1206, the color reproduction area calculator 304 calculates an adjustment value that equalizes the printing colors of the image forming apparatus 120b after being replaced and the printing colors and the scanning characteristics of the image forming apparatus 120a before being replaced, and the identification unit 303 transfers the identification result prompting adjustment of the image forming apparatus 120b and the adjustment value to the portable device 122, and the process ends.

In this embodiment, a gamma conversion parameter set to an image processing described below (gamma conversion process) is adjusted in S1206. Assuming color patches in

YMCK with different density as input (the horizontal axis) and target values (output results of YMCK by the image processing apparatus before being replaced) as output (the vertical axis), it is possible to identify gamma conversion parameters for each of YMCK from the relationship between the input and output for each of YMCK.

In addition, if it is determined that only the differences in pixel values of the scanned images of the documents are identical to or less than the threshold in S1205, the process branches to S1207. In S1207, the identification unit 303 transfers the identification result prompting adjustment of the printer included in the image forming apparatus 120b to the portable device 122, and the process ends.

Furthermore, if it is determined that only the differences in pixel values of the scanned images of the printed matter of the patch images are identical to or less than the threshold in S1205, the process branches to S1208. In S1208, the identification unit 303 acquires the captured image of the documents associated with the identification information of the image forming apparatuses 120a and 120b to be compared that the portable device 122 transfers from the storage unit 302.

In S1209, the identification unit 303 identifies whether or not differences between the pixel values of pixels (RGB values) included in the captured images of the documents of the image forming apparatus 120a before being replaced and the pixel values of pixels (RGB values) included in the captured images of the documents of the image forming apparatus 120b after being replaced are identical to or less than a predetermined threshold. In this embodiment, it is preferable to adopt the difference in the pixel values unrecognizable by the naked eye as the predetermined threshold.

If the differences of the pixel values of the pixels included in the captured images of the documents are identical to or less than the predetermined threshold (YES in S1209), the process branches to S1210. In S1210, the identification unit 303 calculates an adjustment value that equalizes the printing colors and the scanning characteristics of the image forming apparatus 120b after being replaced and the printing colors and the scanning characteristics of the image forming apparatus 120a before being replaced and transfers the identification result prompting adjustment of the image forming apparatus 120b and the adjustment value to the portable device 122, and the process ends.

In this embodiment, it is desired to adjust image processing parameters (the linear masking process parameters, the three-dimensional LUT conversion parameters, and the gamma conversion parameters). It is possible to adjust the parameters using the method described above.

By contrast, if the differences of the pixel values of the pixels included in the captured images of the documents are larger than the threshold, i.e., the documents are different after the image forming apparatus is replaced (NO in S1209), the process branches to S1211. In S1211, the identification unit 303 transfers the identification result indicating that it is impossible to identify the image forming apparatuses 120a and 120b to the portable device 122, and the process ends.

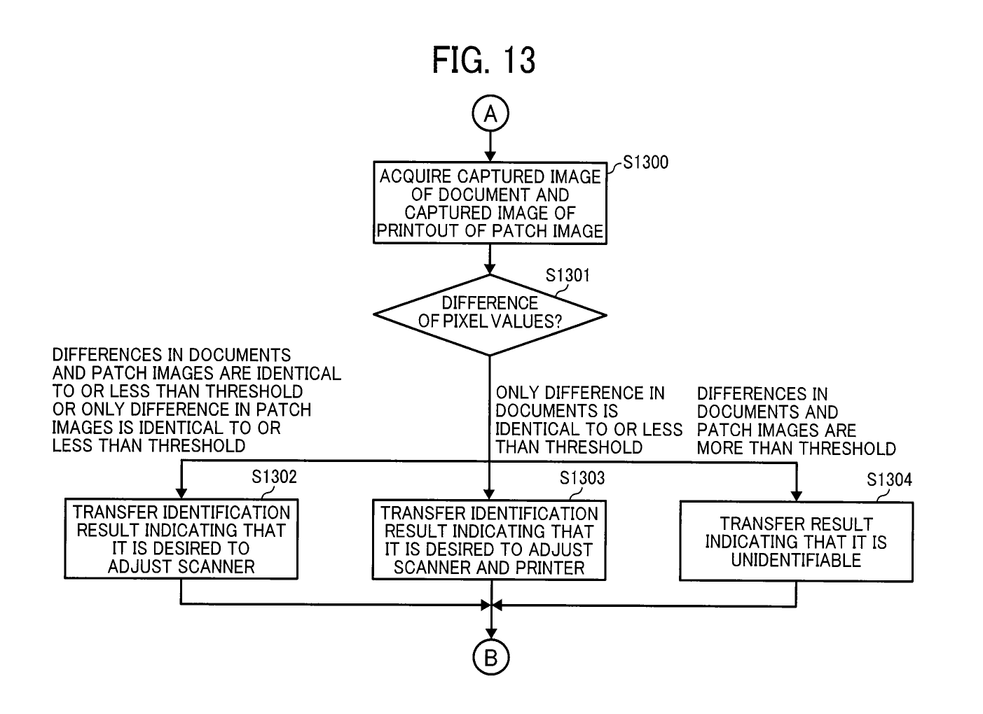

Furthermore, if it is determined that the differences in the pixel values of the scanned images of the documents are larger than the predetermined threshold and the differences in the pixel values of the scanned images of the printed matter of the patch images are larger than the predetermined threshold in S1205, the process branches to S1300 in FIG. 13. In S1300, the identification unit 303 acquires the captured image of the documents and the printed matter of the patch images associated with the identification information of the image forming apparatuses 120a and 120b to be compared that the portable device 122 transfers from the storage unit 302.

In S1301, the identification unit 303 identifies whether or not differences between the pixel values of pixels (RGB values) included in the captured images of the documents of the image forming apparatus 120a before being replaced and the pixel values of pixels (RGB values) included in the captured images of the documents of the image forming apparatus 120b after being replaced are identical to or less than a predetermined threshold, and the identification unit 303 identifies whether or not difference between the pixel values of pixels (RGB values) included in the captured images of the printed matter of the patch images of the image forming apparatus 120a before being replaced and the pixel values of pixels (RGB values) included in the captured image of the printed matter of the patch images of the image forming apparatus 120b after being replaced are identical to or less than a predetermined threshold. Subsequently, the process branches in accordance with the identification result. In this embodiment, it is preferable to adopt the difference in the pixel values unrecognizable by the naked eye as the predetermined threshold.

More specifically, if the differences in the pixel values of the captured images of the documents and the difference in the pixel values of the captured images of the printed matter of the patch images are identical to or less than the predetermined threshold or only the differences in the pixel values of the captured images of the printed matter of the patch images are identical to or less than the predetermined threshold, the process branches to S1302. In S1303, the identification unit 303 transfers the identification result prompting adjustment of the scanner of the image forming apparatus 120b to the portable device 122, and the process ends.

In addition, if it is determined that only the differences in pixel values of the captured images of the documents are identical to or less than the threshold in S1301, the process branches to S1303. In S1303, the identification unit 303 transfers the identification result prompting adjustment of the scanner and the printer of the image forming apparatus 120b to the portable device 122, and the process ends.

Furthermore, if it is determined that the differences in the pixel values of the captured images of the documents are larger than the predetermined threshold and the differences in the pixel values of the captured images of the printed matter of the patch images are larger than the predetermined threshold in S1301, the process branches to S1304. In S1304, the identification unit 303 transfers the identification result indicating that it is impossible to identify the image forming apparatuses 120a and 120b to the portable device 122, and the process ends.

FIGS. 14A and 14B are flowcharts illustrating a process of identifying an image forming apparatus executed by the server 140 if the image forming apparatuses to be compared are the same type of MFP and the scanned image of a document does not exist in this embodiment.

In FIGS. 14A and 14B, the process starts after executing S1104 shown in FIG. 11. In S1401, the identification unit 303 acquires the scanned image of the printed matter of the target image associated with the identification information of the image forming apparatuses 120a and 120b that the portable device 122 transfers from the storage unit 302.

In S1402, the identification unit 303 identifies whether or not differences between the pixel values of pixels (RGB values) included in the scanned image of the image forming apparatus 120a before being replaced and the pixel values of pixels (RGB values) included in the scanned image of the image forming apparatus 120b after being replaced are identical to or less than a predetermined threshold. In this embodiment, it is preferable to adopt the difference in the pixel values unrecognizable by the naked eye as the predetermined threshold.

If the differences in the pixel values are identical to or less than the predetermined threshold (YES in S1402), the process branches to S1403. In S1403, the identification unit 303 transfers the identification result indicating that the printing colors and the scanning characteristics of the image forming apparatus 120a before being replaced and the image forming apparatus 120b after being replaced are identical or similar to the portable device 122, and the process ends.

By contrast, if the differences of the pixel values of the pixels are larger than the predetermined threshold (NO in S1402), the process branches to S1404. In S1404, the identification unit 303 acquires the captured images of the printed matter of the target image and the scanned images of the printer matter of the patch images associated with the identification information of the image forming apparatuses 120a and 120b that the portable device 122 transfers from the storage unit 302.

In S1405, the identification unit 303 identifies whether or not differences between the pixel values of pixels (RGB values) included in the captured images of the printed matter of the target images of the image forming apparatus 120a before being replaced and the pixel values of pixels (RGB values) included in the captured images of the printed matter of the target images of the image forming apparatus 120b after being replaced are identical to or less than a predetermined threshold, and the identification unit 303 identifies whether or not differences between the pixel values of pixels (RGB values) included in the scanned images of the printed matter of the patch images of the image forming apparatus 120a before being replaced and the pixel values of pixels (RGB values) included in the scanned images of the printed matter of the patch images of the image forming apparatus 120b after being replaced are identical to or less than a predetermined threshold. Subsequently, the process branches in accordance with the identification result. In this embodiment, it is preferable to adopt the difference in the pixel values unrecognizable by the naked eye as the predetermined threshold.

If the differences in the pixel values of the captured images of the printed matter of the target image and the differences in the pixel values of the scanned images of the patch images are identical to or less than the predetermined threshold or only the differences in the pixel values of the captured images of the printed matter of the target images are identical to or less than the predetermined threshold, the process branches to S1406.

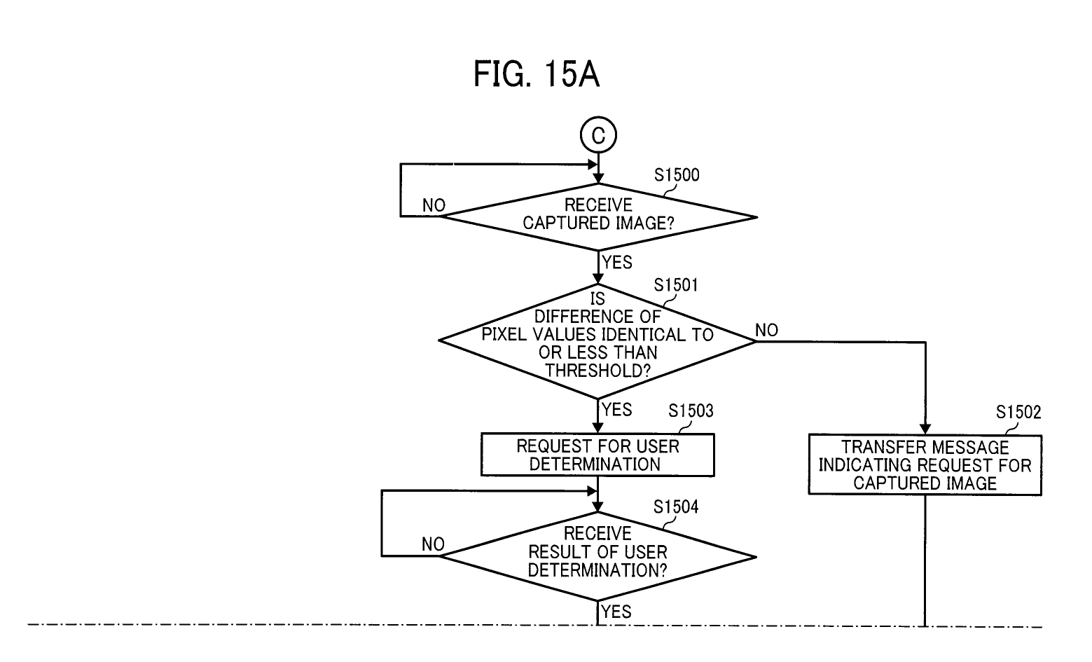

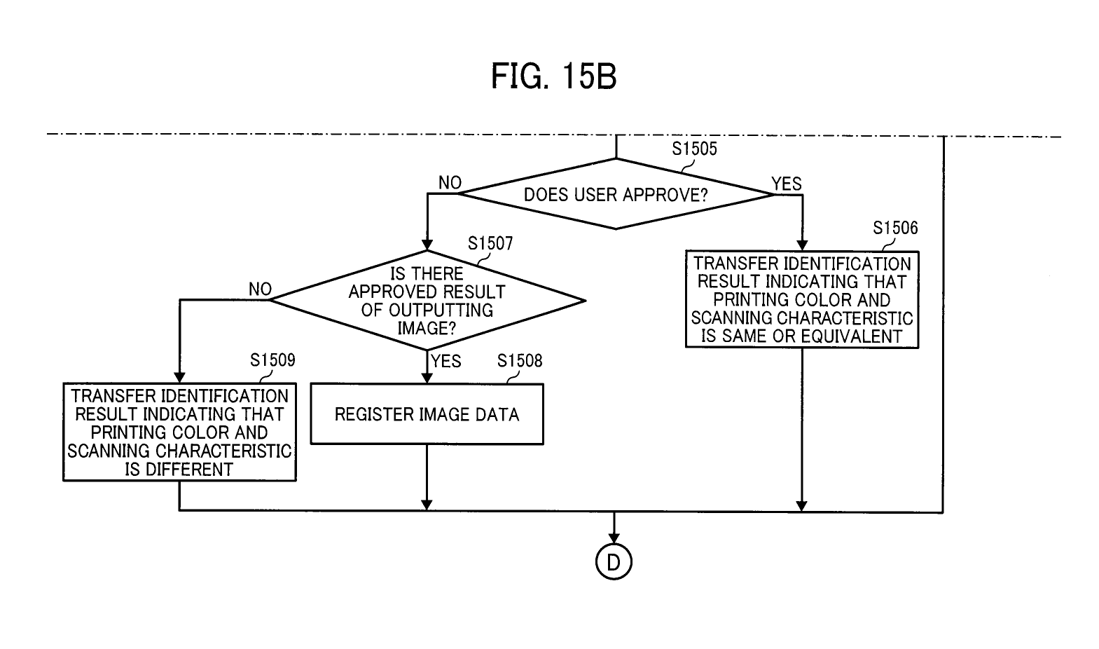

In S1406, the identification unit 303 transfers a message indicating that it is desired to calibrate the capturing device and prepare a captured image of printed matter of the target image after the calibration to the portable device 122. Subsequently, the identification unit 303 identifies whether or not the captured image of the printed matter of the target image is received from the portable device 122 in S1500 in FIGS. 15A and 15B. If the captured image has not been received (NO in S1500), the step S1500 is repeated until the captured image is received. By contrast, if the captured image has been received (YES in S1500), the process branches to S1501.

In S1501, the identification unit 303 identifies whether or not differences between the pixel values of pixels (RGB values) included in the captured images of the printed matter of the target images before the calibration acquired in S1404 and the pixel values of pixels (RGB values) included in the captured images of the printed matter of the target images acquired in S1500 after the calibration are identical to or less than a predetermined threshold. In this embodiment, it is preferable to adopt the difference in the pixel values unrecognizable by the naked eye as the predetermined threshold.

If the differences of the pixel values of the pixels included in the captured images of the printed matter of the target images are larger than the predetermined threshold (NO in S1501), the process branches to S1502. In S1502, the identification unit 303 transfers a message indicating that it is desired to transfer the captured images of the printed matter of the target images, the patch images, and the documents to the portable device 122, and the process ends. In this case, it is requested to identify the image forming apparatuses using the portable device 122 by user operation, and the captured images described above are transferred to the server 140 using the portable device 122 by user operation.

By contrast, if it is determined that the differences of the pixel values of the captured images of the printed matter of the target images are identical to or less than the predetermined threshold (YES in S1501), the process branches to S1503. In S1503, the identification unit 303 requests user determination using the portable device 122.

In S1504, the identification unit 303 identifies whether or not a result of user determination has been received. If the result of user determination has not been received (NO in S1504), the step S1504 is repeated until the result of user determination is received. By contrast, if the result of user determination has been received (YES in S1504), the process branches to S1505.

In S1505, the identification unit 303 identifies whether or not the result of user determination indicates approval. If the result of user determination indicates approval (YES in S1505), the process branches to S1506. In S1506, the identification unit 303 transfers the identification result indicating that the printing colors and the scanning characteristics of the image forming apparatuses 120a and 120b are identical or similar to the portable device 122, and the process ends.

If the result of user determination does not indicate approval (NO in S1505), the process branches to S1507. In S1507, the identification unit 303 identifies whether or not a result of image output considered as acceptable exists. In this embodiment, it is determined that the result of image output considered as acceptable exists if the differences in the captured images of the printed matter of the image forming apparatuses to be compared are identical to or less than a predetermined allowance. It is possible to set any value to the predetermined allowance by user operation.

If the result of image output considered as acceptable exists (YES in S1507), the process branches to S1508. In S1508, the identification unit 303 registers the image data, and the process ends. In this embodiment, the image data used for the evaluation, that is, the scanned images of the output result and the color patches is registered. If the captured images are used, the captured images are registered.

By contrast, if the result of image output considered as acceptable does not exist (NO in S1507), the process branches to S1509. In S1509, the identification unit 303 transfers the identification result indicating that the printing colors and the scanning characteristics of the image forming apparatuses 120a and 120b are different to the portable device 122, and the process ends.

In addition, if it is determined that only the differences in pixel values of the scanned images of the patch images are identical to or less than the threshold in S1405 in FIGS. 14A and 14B, the process branches to S1407.

In S1407, the identification unit 303 calculates an adjustment value that equalizes the printing colors of the image forming apparatus 120b after being replaced and the printing colors and the scanning characteristics of the image forming apparatus 120a before being replaced and transfers the identification result prompting adjustment of the image forming apparatus 120b and the adjustment value to the portable device 122, and the process ends.

In this embodiment, the image processing parameters (the three-dimensional LUT conversion parameters and the gamma conversion parameters) are adjusted in S1407. It is possible to adjust image density by using the gamma conversion parameters and adjust hue by using the three-dimensional LUT conversion parameters. It is possible to adjust those parameters using the method described above.

Furthermore, if it is determined that the differences in the pixel values of the captured images of the printed matter of the target documents are larger than the predetermined threshold and the differences in the pixel values of the scanned images of the patch images are larger than the predetermined threshold in S1405, the process branches to S1408.

In S1408, the identification unit 303 acquires the captured image of the printed matter of the patch images associated with the identification information of the image forming apparatuses 120a and 120b to be compared that the portable device 122 transfers from the storage unit 302. In S1409, the identification unit 303 identifies whether or not differences between the pixel values of pixels (RGB values) included in the captured images of the patch images of the image forming apparatus 120a before being replaced and the pixel values of pixels (RGB values) included in the captured images of the patch images of the image forming apparatus 120b after being replaced are identical to or less than a predetermined threshold.

If the differences of the pixel values of the pixels included in the captured images of the patch images are identical to or less than the predetermined threshold (YES in S1409), the process branches to S1410. In S1410, the identification unit 303 transfers the identification result prompting adjustment of the scanner of the image forming apparatus 120b to the portable device 122, and the process ends.

By contrast, if the differences of the pixel values of the pixels included in the captured images of the patch images are larger than the predetermined threshold (NO in S1409), the process branches to S1411. In S1411, the identification unit 303 transfers the identification result prompting adjustment of the printer of the image forming apparatus 120b to the portable device 122, and the process ends.

FIGS. 16A and 16B are flowcharts illustrating a process of identifying the image forming apparatuses executed by the server 140 if the MFPs as the image forming apparatuses to be compared are different types in this embodiment.

In FIGS. 16A and 16B, the process starts after executing S1105 shown in FIG. 11. In S1601, the identification unit 303 acquires the scanning characteristic information associated with the identification information of the image forming apparatuses 120a and 120b that the portable device 122 transfers from the storage unit 302 and identifies whether or not the scanning characteristics of the image forming apparatus 120a before being replaced and the image forming apparatus 120b after being replaced are equal. If the scanning characteristics of the image forming apparatuses 120a and 120b are identical or similar (YES in S1601), the process branches to S1603.

In S1603, the identification unit 303 acquires the scanned images associated with the identification information of the image forming apparatuses 120a and 120b that the portable device 122 transfers from the storage unit 302. In S1604, the identification unit 303 identifies whether or not differences between the pixel values of pixels (RGB values) included in the scanned image of the image forming apparatus 120a before being replaced and the pixel values of pixels (RGB values) included in the scanned image of the image forming apparatus 120b after being replaced are identical to or less than a predetermined threshold. Subsequently, the process branches in accordance with the identification result. In this embodiment, it is preferable to adopt the difference in the pixel values unrecognizable by the naked eye as the predetermined threshold.

More specifically, if the differences in the pixel values of the scanned images of the printed matter of the target image are identical to or less than the predetermined threshold, the process branches to S1605. In S1605, the identification unit 303 transfers the identification result indicating that the printing colors and the scanning characteristics of the image forming apparatuses 120a and 120b are identical or similar to the portable device 122, and the process ends.

If it is determined that only the differences in pixel values of the documents and the patch images are identical to or less than the threshold in S1604, the process branches to S1606.

In S1606, the identification unit 303 calculates an adjustment value that equalizes the printing colors of the image forming apparatus 120b after being replaced and the printing colors and the scanning characteristics of the image forming apparatus 120a before being replaced and transfers the identification result prompting adjustment of the image forming apparatus 120b and the adjustment value to the portable device 122, and the process ends.

In this embodiment, it is desired to adjust the image processing parameter (the gamma conversion parameters) or the image processing parameters (the linear masking process parameters, the three-dimensional LUT conversion parameters, and the gamma conversion parameters) in S1606. It is possible to adjust those parameters using the method described above.

If it is determined that only the differences in pixel values of the scanned images of the patch images are identical to or less than the threshold in S1604, the process branches to S1607.

In S1607, the identification unit 303 acquires the captured image of the documents associated with the identification information of the image forming apparatuses 120a and 120b to be compared that the portable device 122 transfers from the storage unit 302. In S1608, the identification unit 303 identifies whether or not differences between the pixel values of pixels (RGB values) included in the captured images of the documents of the image forming apparatus 120a before being replaced and the pixel values of pixels (RGB values) included in the captured images of the documents of the image forming apparatus 120b after being replaced are identical to or less than a predetermined threshold. If the differences in the pixel values are identical to or less than the predetermined threshold (YES in S1608), the process branches to S1606.

By contrast, if the differences of the pixel values of the pixels are larger than the predetermined threshold (NO in S1608), the process branches to S1609. In S1609, the identification unit 303 transfers the identification result indicating that it is impossible to identify the image forming apparatuses 120a and 120b to the portable device 122, and the process ends.

If it is determined that only the differences in pixel values of the scanned images of the documents are identical to or less than the threshold in S1604, the process branches to S1610. In S1610, the identification unit 303 transfers the identification result prompting adjustment of the printer of the image forming apparatus 120b to the portable device 122, and the process ends.

If it is determined that differences in the pixel values of all scanned images are larger than the predetermined threshold, the process branches to S1611. In S1611, the identification unit 303 acquires the captured image of the documents and the printed matter of the patch images associated with the identification information of the image forming apparatuses 120a and 120b to be compared that the portable device 122 transfers from the storage unit 302.

In S1612, the identification unit 303 identifies whether or not differences between the pixel values of pixels (RGB values) included in the captured images of the documents of the image forming apparatus 120a before being replaced and the pixel values of pixels (RGB values) included in the captured images of the documents of the image forming apparatus 120b after being replaced are identical to or less than a predetermined threshold, and the identification unit 303 identifies whether or not differences between the pixel values of pixels (RGB values) included in the captured images of the printed matter of the patch images of the image forming apparatus 120a before being replaced and the pixel values of pixels (RGB values) included in the captured images of the printed matter of the patch images of the image forming apparatus 120b after being replaced are identical to or less than a predetermined threshold.

If the differences of the pixel values of the captured images of the documents are larger than the predetermined threshold and the differences of the pixel values of the captured images of the printed matter of the patch images are larger than the predetermined threshold (NO in S1612), the process branches to S1609. In S1609, the identification unit 303 transfers the identification result indicating that it is impossible to identify the image forming apparatuses 120a and 120b to the portable device 122, and the process ends.

If the differences of the pixel values of the captured images of the documents are identical to or less than the predetermined threshold or the differences of the pixel values of the captured images of the printed matter of the patch images are identical to or less than the predetermined threshold (YES in S1612), the process branches to S1613. In S1613, the identification unit 303 transfers the identification result prompting adjustment of the scanner of the image forming apparatus 120b to the portable device 122, and the process ends.

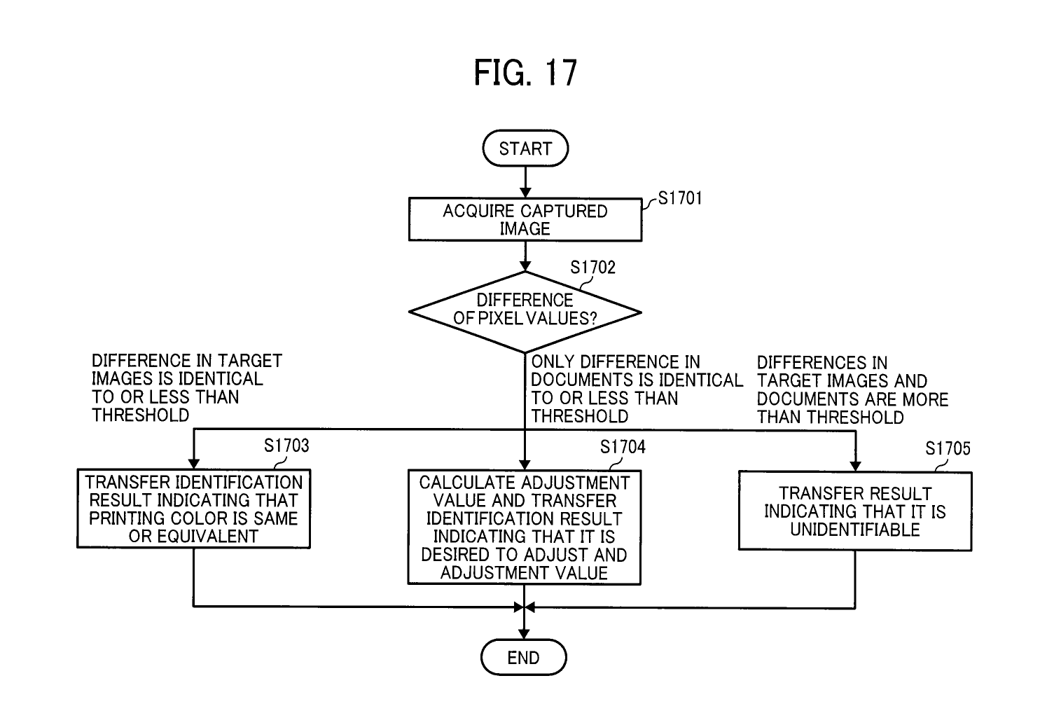

By contrast, if it is determined that the scanning characteristics of the image forming apparatus 120a before being replaced and the image forming apparatus 120b after being replaced are different (NO in S1601), the process branches to S1602. In FIG. 17, the process starts after executing S1602 shown in FIGS. 16A and 16B.

In S1701, the identification unit 303 acquires the captured images of the printed matter of the target image and the documents associated with the identification information of the image forming apparatuses 120a and 120b that the portable device 122 transfers from the storage unit 302. In S1702, the identification unit 303 identifies whether or not differences between the pixel values of pixels (RGB values) included in the captured image of the image forming apparatus 120a before being replaced and the pixel values of pixels (RGB values) included in the captured image of the image forming apparatus 120b after being replaced are identical to or less than a predetermined threshold. Subsequently, the process branches in accordance with the identification result. In this embodiment, it is preferable to adopt the difference in the pixel values unrecognizable by the naked eye as the predetermined threshold.

More specifically, if the differences in the pixel values of the captured images of the printed matter of the target images are identical to or less than the predetermined threshold, the process branches to S1703. In S1703, the identification unit 303 transfers the identification result indicating that the printing colors of the image forming apparatuses 120a and 120b are identical or similar to the portable device 122, and the process ends.

If it is determined that only the differences in pixel values of the captured images of the documents are identical to or less than the threshold in S1702, the process branches to S1704. In S1704, the identification unit 303 calculates an adjustment value that equalizes the printing colors of the image forming apparatus 120b after being replaced and the printing colors and the scanning characteristics of the image forming apparatus 120a before being replaced just the same as in S1006 and transfers the identification result prompting adjustment of the image forming apparatus 120b and the adjustment value to the portable device 122, and the process ends.

If the differences of the pixel values of the captured images of the printed matter of the target images and the differences of the pixel values of the captured images of the documents are larger than the predetermined threshold in S1702, the process branches to S1705. In S1705, the identification unit 303 transfers the identification result indicating that it is impossible to identify the image forming apparatuses 120a and 120b to the portable device 122, and the process ends.

The present invention also encompasses an information processing method. The method includes the steps of storing at least one of a captured image of printed matter printed by a first image forming apparatus and a second image forming apparatus, a scanned image of a document and a patch image scanned by the first image forming apparatus and the second image forming apparatus, a captured image of the document and the printed matter printed by the first image forming apparatus and the second image forming apparatus, and a scanned image acquired by scanning the printed matter and the document by the first image forming apparatus and the second image forming apparatus and identifying a printing color or a scanning characteristic of the first image forming apparatus and the second image forming apparatus, respectively, using at least one of the captured image of the printer matter, the scanned image of the document and the patch image, the captured image of the document and the printed matter, and the scanned image of the printed matter and the document that is stored.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC) and conventional circuit components arranged to perform the recited functions.

What is claimed is:

1. An information processing apparatus, comprising:
a memory to store at least one of
a captured image of printed matter printed by a first image forming apparatus and a second image forming apparatus,
a scanned image of a document and a patch image scanned by the first image forming apparatus and the second image forming apparatus,
a captured image of the document and the printed matter printed by the first image forming apparatus and the second image forming apparatus, and
a scanned image acquired by scanning the printed matter and the document by the first image forming apparatus and the second image forming apparatus; and
an identification unit to identify a printing color or a scanning characteristic of the first image forming apparatus and the second image forming apparatus, respectively, using at least one of the captured image of the printer matter, the scanned image of the document and the patch image, the captured image of the document and the printed matter, and the scanned image of the printed matter and the document that is stored in the memory.

2. The information processing apparatus according to claim 1, further comprising a color reproduction area calculator to calculate a color reproduction area of the first image forming apparatus and the second image forming apparatus, respectively, using the captured image of the printed matter,
wherein the identification unit identifies the printing color of the first image forming apparatus and the second image forming apparatus using the color reproduction area of the first image forming apparatus and the second image forming apparatus to output an identification unit.

3. The information processing apparatus according to claim 1, wherein the identification unit reports the identification result to a user.

4. An image processing system, comprising:
a plurality of image forming apparatuses including a first image forming apparatus and a second image forming apparatus;
a portable device; and
an information processing apparatus to communicate with the image forming apparatus and the portable device,
wherein the portable device captures a document and printed matter printed by the first image forming apparatus and the second image forming apparatus and transfers a captured image to the information processing apparatus,
the first image forming apparatus and the second image forming apparatus each transfer a scanned image acquired by scanning the document and a patch image or a scanned image acquired by scanning the printed matter and the document to the information processing apparatus, and
the information processing apparatus comprises an identification unit to identify a printing color or a scanning characteristic of the first image forming apparatus and the second image forming apparatus using the captured image and/or the scanned image.

5. The image processing system according to claim 4, further comprising a color reproduction area calculator to calculate a color reproduction area of the first image forming apparatus and the second image forming apparatus, respectively, using the captured image,
wherein the identification unit identifies the printing color of the image forming apparatus using the color reproduction area of the first image forming apparatus and the second image forming apparatus to output an identification unit.

6. The image processing system according to claim 4, wherein the identification unit reports the identification result to a user.

7. A non-transitory, computer-readable recording medium storing a program that, when executed by a processor, causes the processor to implement a method of processing information, the method comprising the steps of:
storing at least one of
a captured image of printed matter printed by a first image forming apparatus and a second image forming apparatus,
a scanned image of a document and a patch image scanned by the first image forming apparatus and the second image forming apparatus,
a captured image of the document and the printed matter printed by the first image forming apparatus and the second image forming apparatus, and
a scanned image acquired by scanning the printed matter and the document by the first image forming apparatus and the second image forming apparatus; and
identifying a printing color or a scanning characteristic of the first image forming apparatus and the second image forming apparatus, respectively, using at least one of the captured image of the printer matter, the scanned image of the document and the patch image, the captured image of the document and the printed matter, and the scanned image of the printed matter and the document that is stored.

8. The non-transitory, computer-readable recording medium storing a program that, when executed by the processor, causes the processor to implement the method of processing information according to claim 7, the medium further storing program code that causes the processor to calculate a color reproduction area of the first image forming apparatus and the second image forming apparatus using the captured image,
wherein the identifying step further comprises the step of identifying the printing color of the image forming apparatus using the color reproduction area of the first image forming apparatus and the second image forming apparatus.

9. The non-transitory, computer-readable recording medium storing a program that, when executed by the processor, causes the processor to implement the method of processing information according to claim 7, the medium further storing program code that causes the processor to output an identification result.
